(19) United States
(12) Patent Application Publication
(10) Pub. No.: US 2024/0070185 A1
(43) Pub. Date: Feb. 29, 2024

(54) Timeline Building System

(71) Applicant: Albert G. Blakey, York, PA (US)

(72) Inventor: Albert G. Blakey, York, PA (US)

(21) Appl. No.: 18/322,361

(22) Filed: May 23, 2023

Related U.S. Application Data
(60) Provisional application No. 63/344,883, filed on May 23, 2022.

(51) Int. Cl. G06F 16/435; G06F 16/48

(52) U.S. Cl. CPC G06F 16/435; G06F 16/489

(57) ABSTRACT

A timeline builder system includes a content preparation module creating a back-end user framework in a plurality of bundles of content. The timeline builder system further includes an event creation module retains and assembles a data set from the content preparation module. The timeline builder system further includes a narrative display module receives an assembled data set and displays the assembled data to a front end user.

### CROSS-REFERENCE TO RELATED APPLICATION

The application claims the benefit of the filing date of Provisional Patent Application No. 63/344,883, filed on May 23, 2022.

### FIELD OF THE INVENTION

The invention relates to a timeline building system and, more particularly, to a fully integrated interactive timeline building system.

### BACKGROUND

The invention is a unique concept, and custom configuration, applied to content management systems (“CMS”) used to manage databases and the online experiences available to database users. It is a timeline-driven digital archive system that is well suited to any type of narrative work (a) where time is an important element, (b) there are multiple storylines that relate to each other, and (c) where usage of various forms of media can enrich the power of narrative by enhancing the story consuming experiences of audience members. The invention is applicable both to works of non-fiction and fiction.

The uniqueness of the invention pertains to a set of reciprocating capabilities for back-end users (creators of content) and front-end users (consumers of content). Back-end users can develop multiple, interrelated storylines, organized across time and by different themes—while front-end users can choose how they wish to consume storylines by selecting the sequences of events, and the depth of detail, that strike their interests at a given moment. The invention provides creators a flexible system for publishing their work while knowing that their target audiences will enjoy broad freedom in how individual content consumers choose to experience a creator's work.

The growing popularity of television delivered through streaming services, e-readers such as Kindles, and audio podcasts on various platforms, collectively indicate a market appetite for user-directed consumption of internet-based content over a range of devices. However, while each of these forms of work may be organized into chapters or episodes, a user's experience is typically linear, following a creator prescribed path from beginning to end.

A unique concept of the invention provides for the disaggregation of events from a monolithic narrative, while preserving the coherence of each event to other events, by means of multiple indexes that can be applied to each individual event. These indexes include placement in time as well as assignment to a plurality of creator defined thematic categories. By virtue of this unique organizing principle, front-end users (consumers of content) have the means to assemble sets of events that interest them by using parameters established by back-end users (creators of content).

The invention's method for consumer driven narrative assembly is a key to its uniqueness. An exemplary front-end user first considers a list of content themes or categories and selects one or more categories of interest. The invention then generates a timeline that renders each event matching a chosen category (or categories) in a chronological sequence of dates and descriptive titles for each event. The underlying taxonomy of content categories, event descriptions and dates is determined by back-end users of the invention as they curate content for front-end user consumption, all of which is archived in a database within an exemplary instance of the invention.

An exemplary front-end user might assemble a set of events across multiple categories, and by viewing the events summarized in an exemplary timeline, consider how the included events run concurrently versus sequentially. This user might then expand their chosen tableau by selecting more categories or might un-select some categories in order to focus their view on a more narrowly defined event set.

At any moment, a front-end user may shift from appreciating sequences of selected events across a timeline to exploring any particular event in greater depth. The invention accommodates a front-end user's interest in further detail by providing, within each event, a plurality of curated content elements potentially available for selection, such as text, image, audio and video file types.

For comparison, an exemplary reader of a conventionally published work (whether printed on paper or displayed on an electronic device) who is curious to know how information found in one part of the work relates to information available in other parts of the work, typically has only a Table of Contents and perhaps an Index to consult (if either is included as part of an exemplary work in the first place). The utility of these well-known features is limited in both cases. A Table of Contents typically appears at the front and lists the sequential placement of large blocks of content that follow. An Index typically appears at the end and lists the prior page locations where specific words or subjects are mentioned. It is then left to exemplary readers to jump back and forth between page locations to satisfy their curiosity about the related information they are seeking.

The invention enables front-end users to create their own unique experiences in consuming content by allowing them to self navigate through a creator's offerings as their temporal experience of curiosity emerges. Subsequent selections are based on their level of interest in selections they have previously made, giving an exemplary front-end user significant freedom to explore an exemplary back-end user's work product.

For back-end (content creating) users, their knowledge of the enhanced consumer experiences made possible by the invention now provides them with a greatly expanded palette of possibilities for conceiving, developing and publishing their work.

When considering creative choices such as depths of detail used to describe anything (for example: an event, a setting or a scene, the build-up of preceding events, the attributes or motives of principal versus secondary characters, foreshadowing subsequent events, etc.) a content creating back-end user can choose to consolidate or distribute information within or among specific event records using the invention, knowing that a content consuming front-end user can dive deeper, if intrigued, or move along more swiftly, if they prefer.

Moreover, whether developing non-fiction or fictional narratives, a content creator can work with time as a creative element, knowing that a content consuming front-end user will be able to look broadly across concurrent events or stay tightly focused on a particular narrative thread. Lastly, a content producer can include a plurality of media file types to enrich a front-end user's experience, each placed precisely in context, and easily accessed by any front-end user who is interested.

Therefore, there is currently a need for a system to provide the unique capabilities that enable an overall well rounded and broad exploration of curated content for a user.

### SUMMARY

A timeline builder system is provided and includes a content preparation module creating a back-end user framework in a plurality of bundles of content. The timeline builder system further includes an event creation module retains and assembles a data set from the content preparation module. The timeline builder system further includes a narrative display module receives an assembled data set and having a content filter module providing a plurality of content categories which are selected or deselected by a front-end user. The narrative display module further having an event timeline module receives the plurality of content categories selected by the front-end user and displayed on a portion a screen of the narrative display module. The narrative display module further having an event display module displays the plurality of content categories and permits the front-end user to explore and consume content related to the event timeline module. The narrative display module further having a fixed element module positioned across a top portion of the screen and providing a plurality of menu options.

### BRIEF DESCRIPTION OF DRAWINGS

FIG. 1 is a schematic diagram of a timeline builder system according to the invention;

FIG. 2 is another schematic diagram of a timeline builder system according to the invention;

FIG. 3 is another schematic diagram of a timeline builder system according to the invention;

FIG. 4 is a schematic diagram of an event display module of the timeline builder system according to the invention;

FIG. 5 is a schematic diagram of a narrative display module of the timeline builder system according to the invention;

FIG. 6 is a schematic diagram of a case example of a functioning timeline builder system according to the invention;

FIG. 7 is another schematic diagram of a case example of a functioning timeline builder system according to the invention;

FIG. 8 is another schematic diagram of a case example of a functioning timeline builder system according to the invention;

FIG. 9 is a schematic view of a front-end user environment of a timeline builder system according to the invention as viewed through a general user interface on a window based computer;

FIG. 10 is another schematic view of a front-end user environment of a timeline builder system according to the invention as viewed through a general user interface on a window based computer;

FIG. 11 is another schematic view of a front-end user environment of a timeline builder system according to the invention as viewed through a general user interface on a window based computer;

FIG. 12 is another schematic view of a front-end user environment of a timeline builder system according to the invention as viewed through a general user interface on a window based computer;

FIG. 13 is another schematic view of a front-end user environment of a timeline builder system according to the invention as viewed through a general user interface on a window based computer;

FIG. 14 is another schematic view of a front-end user environment of a timeline builder system according to the invention as viewed through a general user interface on a window based computer;

FIG. 15 is another schematic view of a front-end user environment of a timeline builder system according to the invention as viewed through a general user interface on a window based computer;

FIG. 16 is another schematic view of a front-end user environment of a timeline builder system according to the invention as viewed through a general user interface on a window based computer;

FIG. 17 is another schematic view of a front-end user environment of a timeline builder system according to the invention as viewed through a general user interface on a window based computer;

FIG. 18 is another schematic view of a front-end user environment of a timeline builder system according to the invention as viewed through a general user interface on a window based computer;

FIG. 19 is another schematic view of a front-end user environment of a timeline builder system according to the invention as viewed through a general user interface on a window based computer;

FIG. 20 is a schematic view of a front-end user environment of a timeline builder system according to the invention as viewed through a general user interface on a mobile based computing device;

FIG. 21 is another schematic view of a front-end user environment of a timeline builder system according to the invention as viewed through a general user interface on a mobile based computing device;

FIG. 22 is another schematic view of a front-end user environment of a timeline builder system according to the invention as viewed through a general user interface on a mobile based computing device;

FIG. 23 is another schematic view of a front-end user environment of a timeline builder system according to the invention as viewed through a general user interface on a mobile based computing device;

FIG. 24 is another schematic view of a front-end user environment of a timeline builder system according to the invention as viewed through a general user interface on a mobile based computing device;

FIG. 25 is another schematic view of a front-end user environment of a timeline builder system according to the invention as viewed through a general user interface on a mobile based computing device;

FIG. 26 is another schematic view of a front-end user environment of a timeline builder system according to the invention as viewed through a general user interface on a mobile based computing device;

FIG. 27A is a schematic diagram of an exemplary database for a back-end user environment of a timeline builder system according to the invention;

FIG. 27B is a schematic diagram of an exemplary database for a back-end user environment of a timeline builder system according to the invention;

FIG. 28A is a schematic diagram of another exemplary database for a back-end user environment of a timeline builder system according to the invention;

FIG. 28B is a schematic diagram of another exemplary database for a back-end user environment of a timeline builder system according to the invention;

FIG. 29 is a schematic diagram of another exemplary database for a back-end user environment of a timeline builder system according to the invention;

FIG. 30 is a schematic diagram of another exemplary database for a back-end user environment of a timeline builder system according to the invention;

FIG. 31 is a schematic diagram of another exemplary database for a back-end user environment of a timeline builder system according to the invention;

FIG. 32 is a schematic diagram of a back-end user environment of a timeline builder system according to the invention;

FIG. 33 is another schematic diagram of a back-end user environment of a timeline builder system according to the invention;

FIG. 34 is a schematic diagram of a timeline builder system according to the invention;

FIG. 35 is another schematic diagram of a timeline builder system according to the invention;

FIG. 36 is another schematic diagram of a timeline builder system according to the invention; and

FIG. 37 is another schematic diagram of a timeline builder system according to the invention.

### DETAILED DESCRIPTION OF THE EMBODIMENT(S)

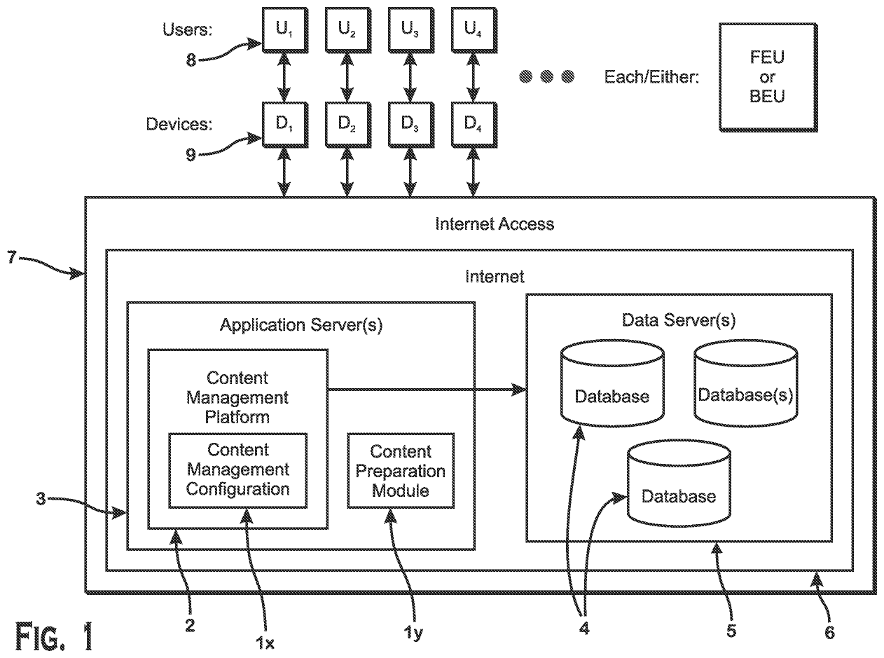

In an embodiment, the teachings herein describe a system that allows for the creation of a timeline-driven digital archive system according to an embodiment of the invention (“timeline builder system 1”). As shown in FIG. 1, a timeline builder system 1 according to the invention generally includes a content management configuration 1X and content preparation module 1Y.

In the exemplary embodiment, the timeline builder system 1 generally includes an application site. One of ordinary skill in the art would understand the applicant's design is not the exclusive embodiment. In the exemplary embodiment, the application site is designed to work on internet Explorer 10+, and the most up-to-date versions of Chrome, Safari and Firefox across all major operating systems and updated device platforms for example Android and IOS. One of ordinary skill in the art would understand the applicant's design is not the exclusive embodiment. In the exemplary embodiment, the application site further includes a main screen module. One of ordinary skill in the art would understand the applicant's design is not the exclusive embodiment.

As shown in FIG. 1, the timeline builder system 1 is depicted in two parts: by way of a content management configuration 1X and a content preparation module 1Y. The content management configuration 1X according to the invention is deployed as a configuration within an exemplary content management platform 2. The content preparation module 1Y according to the invention is an exemplary set of templates and tools for use by content creators to identify and organize content elements such as copy, dates and digital files into coherent groupings for subsequent entry into the content management configuration 1X.

The content management platform 2 can be either commercially available to the public or proprietary for the designated use of its owners, Both the content management configuration 1X and the content preparation module 1Y can be housed as applications within a plurality of application servers, 3, In performing their exemplary functions, the application servers, 3, would interface with one or more databases, 4, which would be housed in one or more database servers, 5, each of which, 3, 4, and 5, could be commercially available or proprietary. Each component, 1 thru 5, would be connected to the others via the Internet 6, and would be accessible to a plurality of system users through a plurality of means of Internet access 7. Such users, 8, would utilize a plurality of devices 9 to affect their access to the Internet and thereby utilize each of the components described above to exploit the capabilities of the invention, 1X and 1Y.

In an exemplary embodiment, the plurality of potential users, could be either solely front-end (only content consuming) users FEU, or back-end (content creating) users, BEU.U. In the present shown embodiment, back-end users, BEU, have the ability to consume content at any time, however solely front-end users FEU have only the ability to consume content created by others, and thus have no access to the invention's back-end content creation functionality.

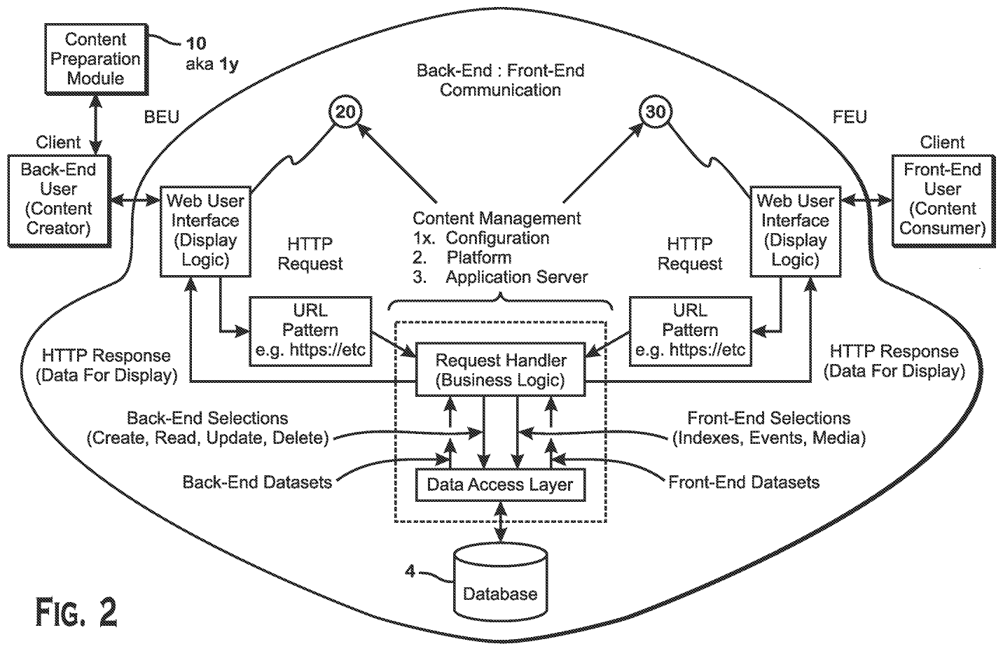

As shown in FIG. 2, an exemplary back-end user BEU uses the display logic of the web user interface of the content management configuration, 20 (as part of 1X) to send HTTP requests to a content management platform, 2, for actions performed by the application server, 3. Exemplary requests include back-end actions such as create, read, update, delete which are relayed through the data access layer to and from an exemplary database, 4, which then returns back-end datasets for display within the back-end user BEU interface as the exemplary back-end user BEU creates and loads content into the database.

With reference to FIG. 2, a front-end user FEU, uses the display logic of the web user interface of the content management configuration 1X and more specifically the front-end user interface, specifically a narrative display module 30 to send HTTP requests to the content management platform, 2, for actions performed by the application server, 3. Exemplary requests include front-end actions such as accessing indexes of content and selecting various items of content, which are relayed through the data access layer to and from an exemplary database 4, which then returns front-end datasets for display within the front-end user interface as the exemplary front-end user consumes content in the database by means of the invention.

In the shown embodiment, the content preparation module 1Y is available only to a back-end user BEU.

According to the invention, the content preparation module 1Y generally includes a story template module 11, which provides a framework for exemplary creators of content to gather, organize, develop, proofread and approve coherent bundles of content prior to loading into an event creation module 20. The content preparation module 10 further includes a media log module 12 that provides a framework for exemplary creators of content to identify, label and manage digital media files within a unique numbering system that corresponds to entries in the story template module 11.

The content preparation module 10 further includes an event publication summary module 13. The event publication summary module 13 provides a framework for managing work in process, work completed and workflow as content is developed both before and after loading into the event creation module 20.

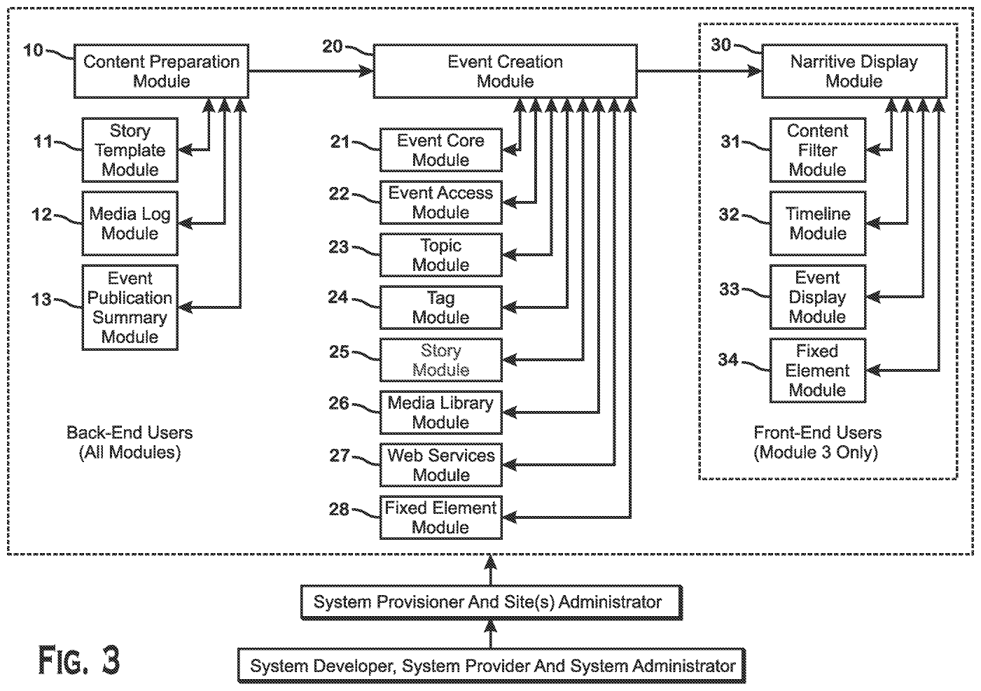

With reference to FIG. 3, an overview of the timeline builder system 1 is shown, whereby the content preparation module 10, the creation module 20, and the narrative display module 30 interact.

The event creation module 20 according to the invention is available only to back-end users BEU. In an exemplary embodiment of the invention, the event creation module 20 generally includes a core event module 21. The core event module 21 is the primary vehicle for the assembly of data within the event creation module, 20, and is where back-end users enter: event titles (full), display titles (brief), sort dates (unique), display dates (varied formats), copy, and media file types, and links to media files. One skilled in the art would understand the applicant's design is not the exclusive embodiment.

In an exemplary embodiment of the invention, the event creation module 20 further includes an event access module 22 that allows back-end users BEU to set permission levels per event, that control access to content by categories of front-end user FEU.

In an exemplary embodiment of the invention, the event creation module 20 further includes a topic module 23 that allows back-end users to create hierarchical taxonomies of categories of content that provide a foundation for front-end user FEU to navigate, select and explore content within an exemplary site.

In an exemplary embodiment of the invention, the event creation module 20 further includes a tag module 24 that allows back-end users BEU to create non-hierarchical taxonomies of categories that provide a foundation for front-end user FEU to navigate, select and explore content within an exemplary site.

In an exemplary embodiment of the invention, the event creation module 20 further includes a story module 25. The story module 25, allows back-end users to create custom sets of content independent of any topic modules 23 and tag modules 24 otherwise assigned within the modules.

In an exemplary embodiment of the invention, the event creation module 20 further includes a media library module 26. The media library module 26 is the repository for digital content files within an exemplary archive such as images, sets of multiple images, documents, and audio files.

As shown, the event creation module 20 further includes a plurality of web services modules 27. The plurality of web services modules 27 provide back-end users with enhanced capabilities to render content within an exemplary archive such as PDF readers, video players, embedded URLs, etc.

In an exemplary embodiment of the invention, the event creation module 20 further includes a fixed element module 28. The fixed element module 28 is positioned across a top of a display area and provides persistent site and user identification information. It also provides functionality that enables back-end users BEU to switch between the back end and front-end functions of an individual exemplary site, as well as to move from one exemplary site to another exemplary site.

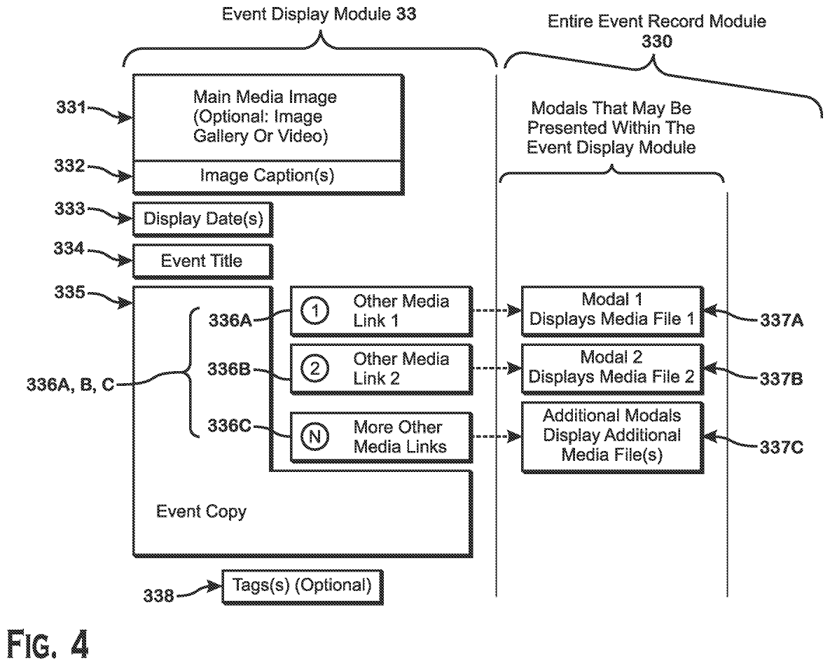

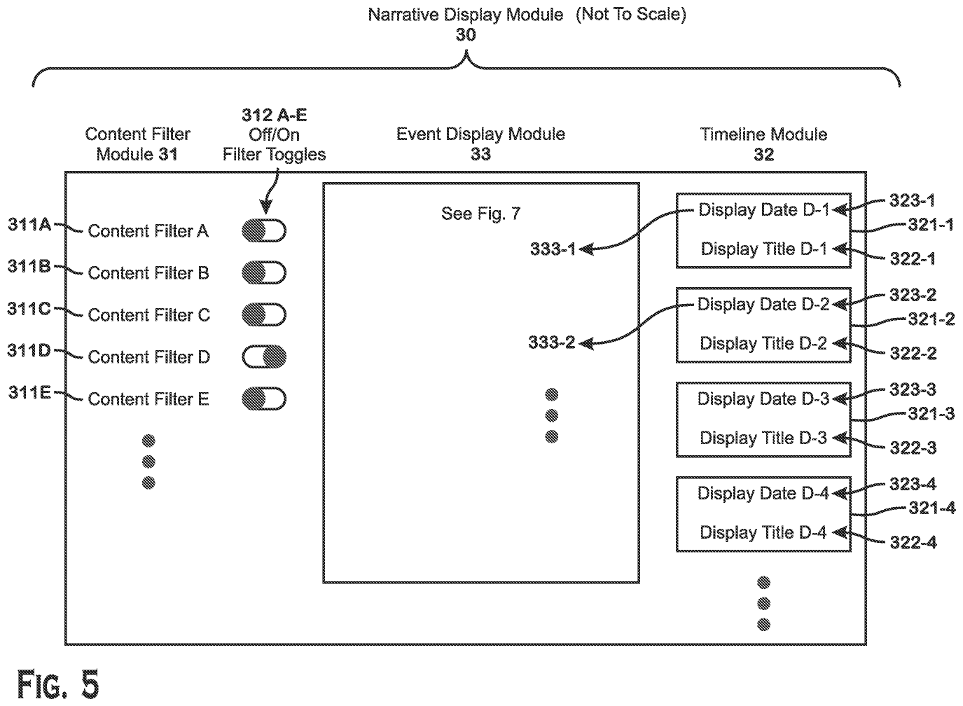

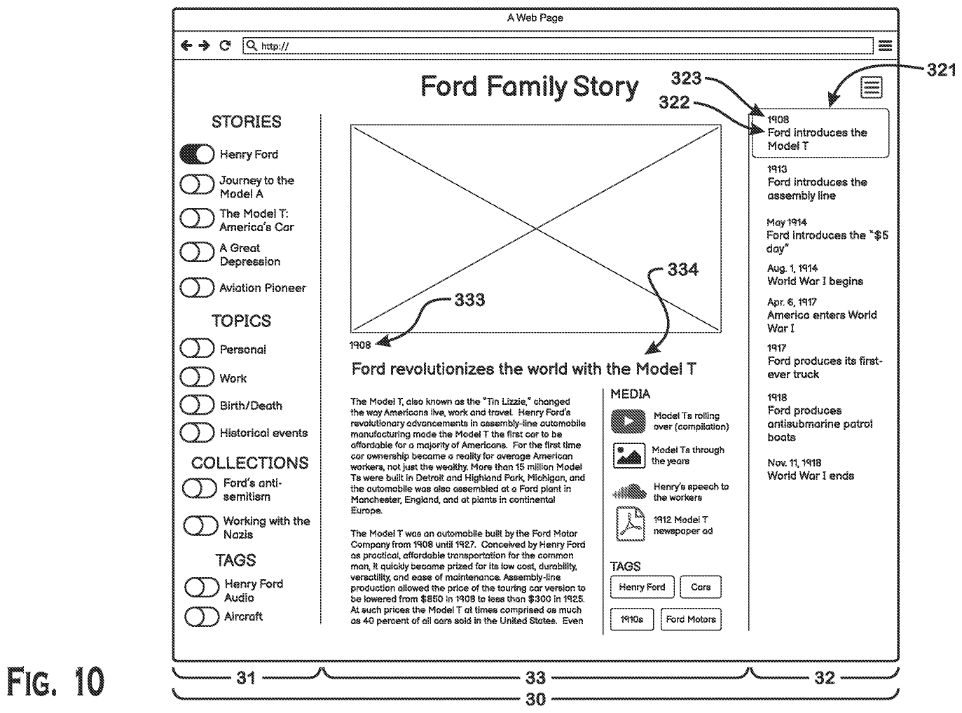

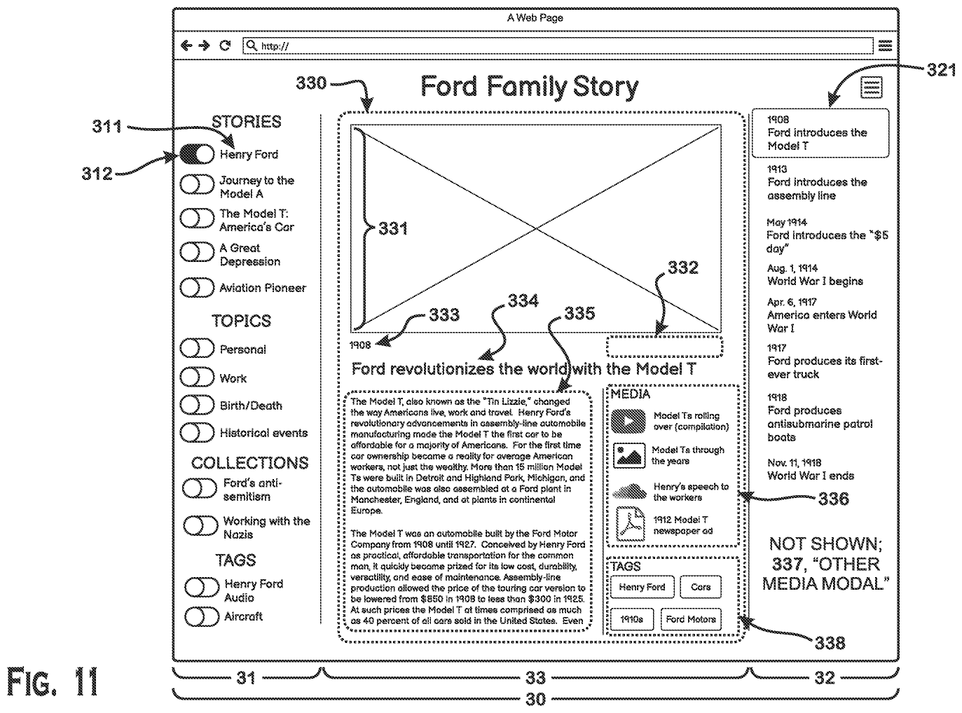

With respect to FIGS. 4-5, FIG. 4 will be discussed congruently with FIG. 10-11.

In an exemplary embodiment of the invention, the event creation module 20 further includes a life lessons module 29. The life lessons module 29 allows back-end users to create custom sets of media file content that are accessed by front-end users independent of any content filter modules 31 and event timeline modules 32 otherwise assigned within the modules.

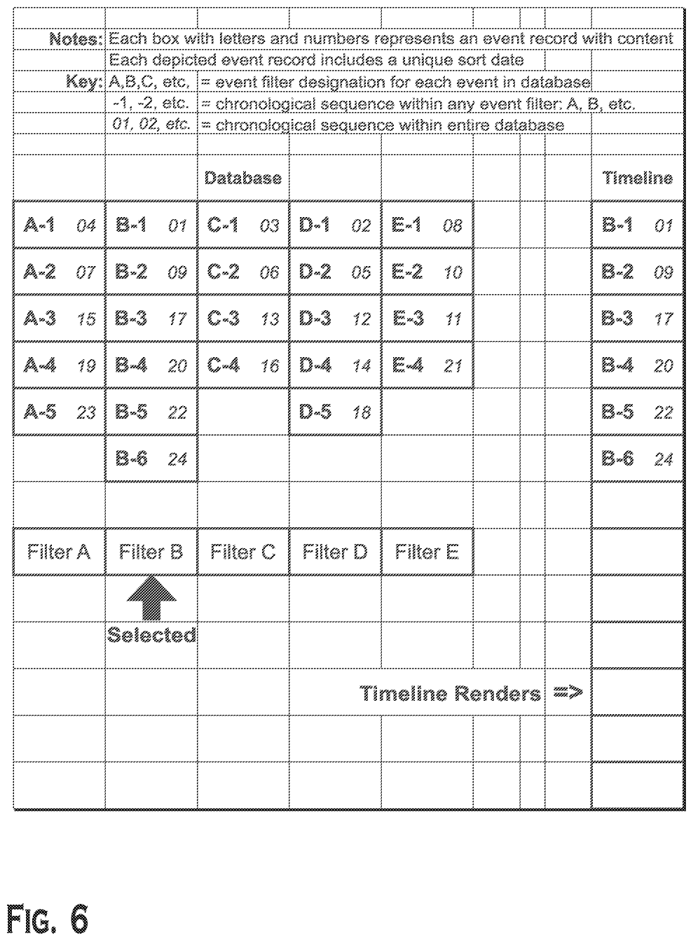

The underlying algorithm with reference to FIGS. 6-8 enable a content management available to the front-end user FEU and the back-end users BEU. The underlying algorithm will be portrayed in three examples.

As shown identically in a plurality of keys for FIGS. 6, 7, and 8: each box with letters and numbers represents an event record module 330 with associated content in an exemplary instance of the database. Additionally, each depicted event record module 330 includes a unique sort date as designated by the back-end user BEU within the core event module 21.

The plurality of keys further include Capital Letters. Capital letters such as A, B, C, etc. represent content filter designations for event records in the database, as determined by the back-end user, specifically the taxonomies described above using a plurality of designations within the topic module, 23, the tag module, 24, and/or the story module, 25.

The plurality of keys further includes Dash Numbers. Dash numbers such as −1, −2, etc. represent the chronological sequence of the event records of the content filter 311A-E (see FIG. 5), yielding relative chronological sequences such as A-1, A-2 and B-1, B-2, etc., based on their underlying unique sort date.

The plurality of keys further include Italic Numbers. Italic numbers such as 01, 02, 03, etc. represent the chronological sequence of all event records in an exemplary database, regardless of content filter 311A-E, based on their underlying unique sort date.

Case Example One

As shown in FIG. 6, the area in the figure under the heading “Database” shows an exemplary set of database records with designations conforming to the key and notes above, “A-1” thru “E-4”. Below the database depiction is a set of boxes representing the plurality of content filters 311A-E, of the content filter module 31. An arrow and bold text indicate that for the purposes of the example in FIG. 6, “Filter B” has been selected by the front-end user FEU within the content filter module 31. As a consequence, the column on the right, under the heading “Timeline”, shows an exemplary rendering of a timeline, within the event timeline module 32, that reflects the selection of content “Filter B”, within the content filter module 31. Specifically, all six exemplary records, in chronological order, that are designated under “Filter B”, within the database 4 are shown in the even timeline module 32.

Case Example Two

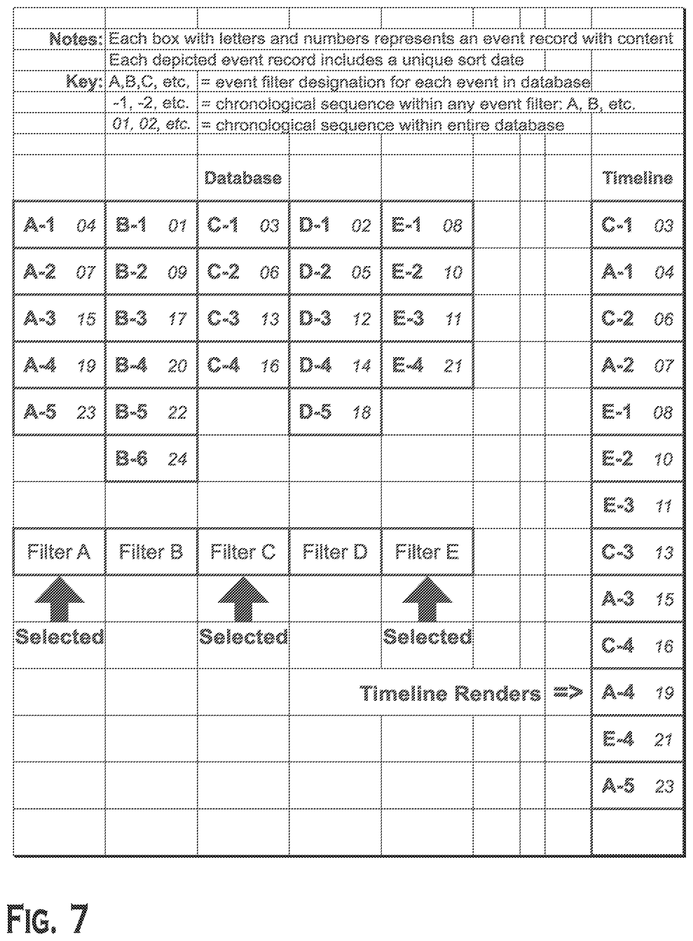

As shown in FIG. 7, the notes, key and exemplary database depiction are identical to FIG. 6. Illustrating a second scenario, arrows and bold text beneath the content filters 311A-E, of the content filter module 31 indicate that for the purposes of the example in FIG. 6, “Filter A”, “Filter C” and “Filter E” have been selected by an exemplary front-end user FEU of the invention. As a consequence, the column on the right, under the heading “Timeline”, shows an exemplary rendering of a timeline within the event timeline module 32 that reflects the selection of these three filters, specifically all thirteen exemplary records, in chronological order, that are designated under “Filter A”, “Filter C” and “Filter E”—noting that the chronological sequence displayed in the timeline is governed by relative placement in time across the entire archive database, as indicated by the numbers in italics: 03, 04, 06, etc.

Case Example Three

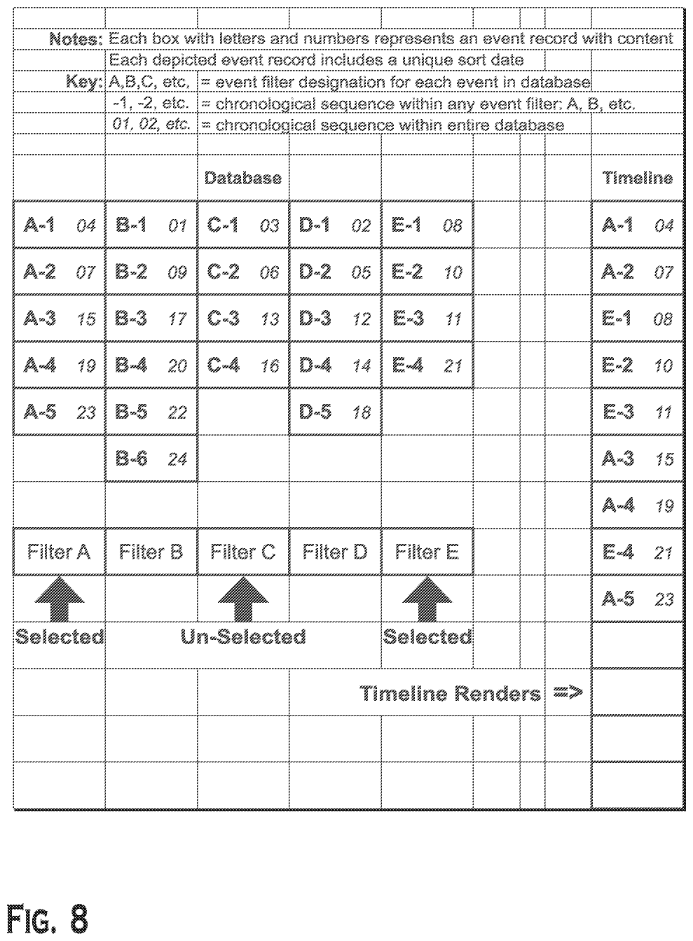

As shown in FIG. 8, the notes, key and exemplary database depiction are identical to FIG. 6 and FIG. 7. Illustrating a third scenario, arrows and bold text beneath the content filters 311A-E indicate that for the purposes of the example in FIG. 8, “Filter C” has been un-selected, whereas “Filter A” and “Filter E” remain selected by an exemplary front-end user FEU within the content filter module 31.

As a consequence, the column on the right, under the heading “Timeline”, shows an exemplary rendering of a timeline, within the event timeline module 32 that reflects the selection of these two filters, and removal of the third filter, specifically all nine exemplary records, in chronological order, that are designated under “Filter A” and “Filter E”—noting that the chronological sequence displayed in the exemplary timeline is governed by relative placement in time across the entire archive database, as indicated by the numbers in italics: 03, 04, 06, etc.

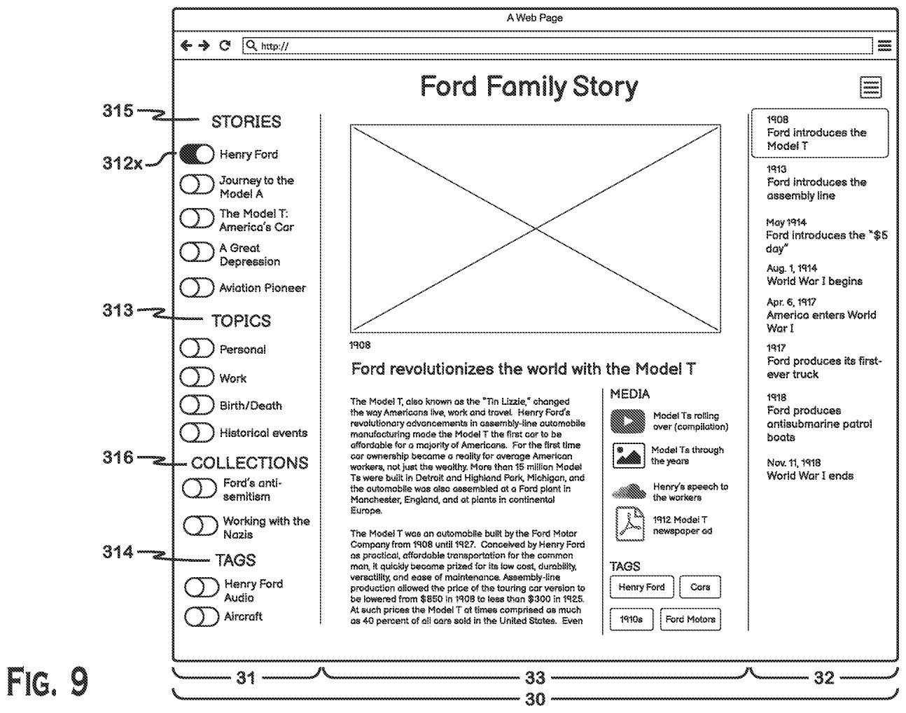

As shown with reference to FIGS. 9-20, a front-end user environment for a timeline builder system is shown as viewed through a general user interface on a window based computer.

As shown, the content management configuration 1X includes the narrative display module 30. In the exemplary embodiment the narrative display module 30 is generally composed of the following major panels: a content filter module 31, a timeline module 32, an event display module 33 and a fixed element module 34.

In the exemplary embodiment, the narrative display module 30 allows the user to select and deselect the events displayed in the timeline module 32. One of ordinary skill in the art would understand the applicant's design is not the exclusive embodiment.

In an exemplary embodiment of the invention, the content filter module 31 allows a front-end user FEU to view and make selections among content categories established by a back-end user BEU. Specifically, within the topic module 23, the tag module 24 and the story module 25. In the exemplary embodiment, the content filter module 31 will include a button in a desktop view that allows the content filter module 31 to be collapsed, so that more space is given to the event display module 33. One of ordinary skill in the art would understand the applicant's design is not the exclusive embodiment. In the exemplary embodiment, when the button is selected again, the content filter module 31 will be visible.

In an exemplary embodiment of the invention, the content filter module 31 provides the plurality of content categories 313, 314, 315, and 316 As shown in FIG. 9. The plurality of content categories 313, 314, 315, 316 which any individual content filter, 311A-E may be selected or deselected by the front end user FEU by means of an “off/on” toggle switch 312A-E (see FIG. 5). The content filter module 31 is displayed in a vertical panel on the left side of the front-end user FEA's screen. It occupies about 15% to 20% of the horizontal screen area. One skilled in the art would understand the applicant's design is not the exclusive embodiment. The content categories within the content filter module 31 are shown in a vertical list, with a toggle switch 312A-E beside each listed category. The content categories in the list may themselves be grouped into other categories. The content filter module 31 may be scrolled up and down by the front-end user FEU. The front-end user FEU may choose one, or more than one category, according to their interests at any moment during a front-end user FEU session, by clicking its associated toggle switch into the “on” position.

As shown in FIG. 9, the content filer module 31 includes a plurality of topics 313. The plurality of topics 313 are depicted as a list elements. One skilled in the art would understand the applicants design is not the exclusive embodiment. Every event record module 330 is associated with a topic from the plurality of topics 313. In one embodiment, the plurality of topics 313 may be organized in parent-child relationships, thereby allowing exemplary back-end users to create hierarchical content structures.

As shown in FIG. 9, the content filter module 31 further includes a plurality of tags 314. The plurality of tags 314 are depicted as list elements which represent an optional type of content filter, providing the back-end users BEU with an opportunity for a secondary axis of content organization for the event records module 330. Each tag of the plurality of tags 314 are single dimensional and may not in the present embodiment be used to create hierarchical content structures. One skilled in the art would understand the applicant's design is not the exclusive embodiment.

As shown in FIG. 9, the content filter module 31 further includes a plurality of stories 315. The plurality of stories 315 are depicted as list elements in the present embodiment of the content filter module 31. The plurality of stories 315 represent an optional means of grouping event records module 330 whereby the back-end user BEU may designate a set of event records module 330 to present as grouping with its own content filter 311 for selection within the content filter module 31.

As shown in FIG. 9, the content filter module 31 further includes a plurality of collections 316. The plurality of collections 316 of the content filter module 31 represent an optional means of grouping event records module 330 whereby the front-end user FEU may designate the set of event records module 330 to present as grouping with its own content filter 311, for selection within the content filter module 31. Further, a collection of the plurality of collections 316 may be shared by an exemplary front-end user FEU with other front-end users FEU or may be kept private by the exemplary front-end user who created it.

In an exemplary embodiment of the invention, the event timeline module 32 permits all content items that fit the categories selected within the content filter module 31 to be displayed in chronological order for examination by an exemplary front-end user FEU. The event timeline module 32 is displayed in a vertical panel on the right side of the front-end user FEA's screen. It occupies about 15% to 20% of the horizontal screen area. One skilled in the art would understand the applicant's design is not the exclusive embodiment.

As shown in FIG. 10, the event timeline module 32 further includes a plurality of event summaries 321. The plurality of event summaries 321 include a plurality of dates and titles that are consistent with each event. One of ordinary skill in the art would understand the applicant's design is not the exclusive embodiment. The plurality of event summaries 321 further include a display title 322 and a display date 323. The display titles 322 and display dates 323 are shown to the front-end user FEU within each event summary 321 of the plurality of event summaries 321 to aid in the front-end user FEU understanding of the flow and sequence of their respective events across time. Further, the display titles 322 and display dates 323 provide guidance to front-end user FEU who may seek further information and may choose to consume additional content.

As shown in FIG. 11, the event display module 33 permits the front-end user FEU to explore and consume content related to their event selections within the event timeline module 32. The event display module 33 contains an event record module 330. The event record module 330 includes a media file within an event record module image frame 331. The media displayed in the event record module image frame 331 which may be a single image, a series of images (“Gallery”), or a video.

The event record module 330 further includes a caption frame 332 to display image captions for single or multiple images, immediately below the event record module image frame 331 as shown in FIG. 4 and FIG. 11.

As shown in FIG. 11, the event record module 330 further includes a display date frame 333 opposing the caption frame 332. The display date frame 333 conveys a timeframe for the corresponding event in the event record module 330. The back-end user BEU creating an event can choose from a plurality of formats including a date range, a month, a span of months, a season, a year, a span of years, etc. in addition to using a specific date.

As shown in FIG. 11, the event record module 330 further includes an event title frame 334 positioned below the display date frame 333. The event title frame 334 is the largest text element within the event display module 33. One skilled in the art would understand the applicant's design is not the exclusive embodiment. The display date 323 of the event timeline module 32 and the display date, 333, event display module 33, are reported from the same record in an exemplary database.

In contrast, the display title 322 in FIG. 10, in the event timeline module 32, is a different record than an event title frame 334, in the event display module 33 as shown in FIG. 11. The display title 322, is typically shorter than the event title frame 334, which allows for a more succinct title to be used for event summary presentation within the event timeline module, 32, and allows for a longer and more descriptive title to be used for a full event record presentation within the event display module 33.

As shown in FIG. 11, the event record module 330 further includes an event copy frame 335 positioned below the event title frame 334. The event copy frame 335, is the primary text-based means of describing an event. The event copy frame 335 typically provides an explanatory narrative encompassing all other elements of an exemplary displayed event.

As shown in FIG. 11, the event record module 330 further includes an other media title frame 336 positioned to the right of the event copy frame 335. The other media files frame 336 provides links to other media files, and which are indicated by icons and brief text descriptions.

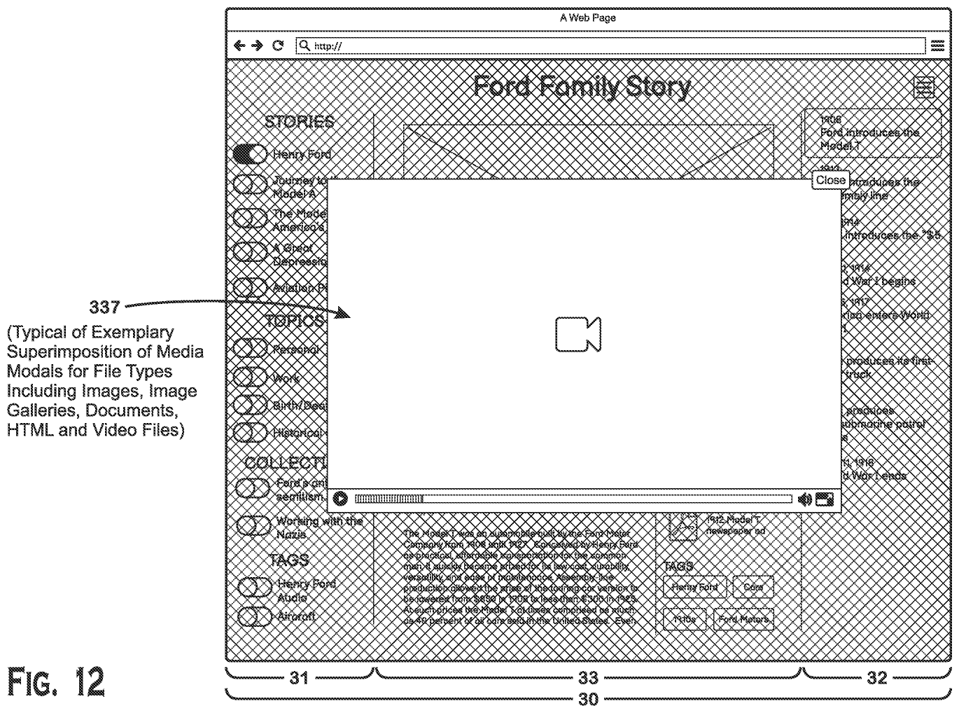

As shown in FIG. 11, the event record module 330 further includes a plurality of media selections within the other media files frame 336. The plurality of media selection are positioned to the right of the event copy frame 335 for exemplary back-end users to provide as supplemental presentations to enrich an exemplary front-end user FEA's experience of a displayed event which contain other media modals 337 As shown in FIG. 12.

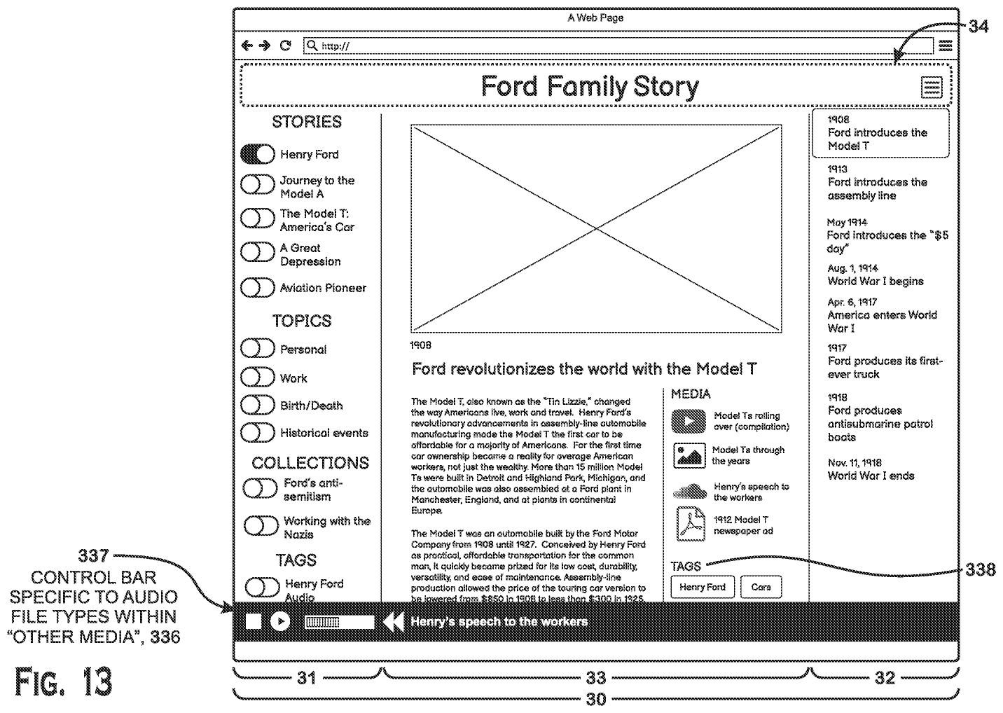

As shown in FIG. 13, the event record module 330 further includes event record tags modules 338. The event record tag modules 338 are positioned below the event copy frame 335 which if clicked allow the front-end user FEU to select other event records for viewing that are likewise associated with the same event records tag module 338. The content filter module 31 and the event timeline module 32 control the event records of the event record module 330 which are selected for display by front-end user FEU.

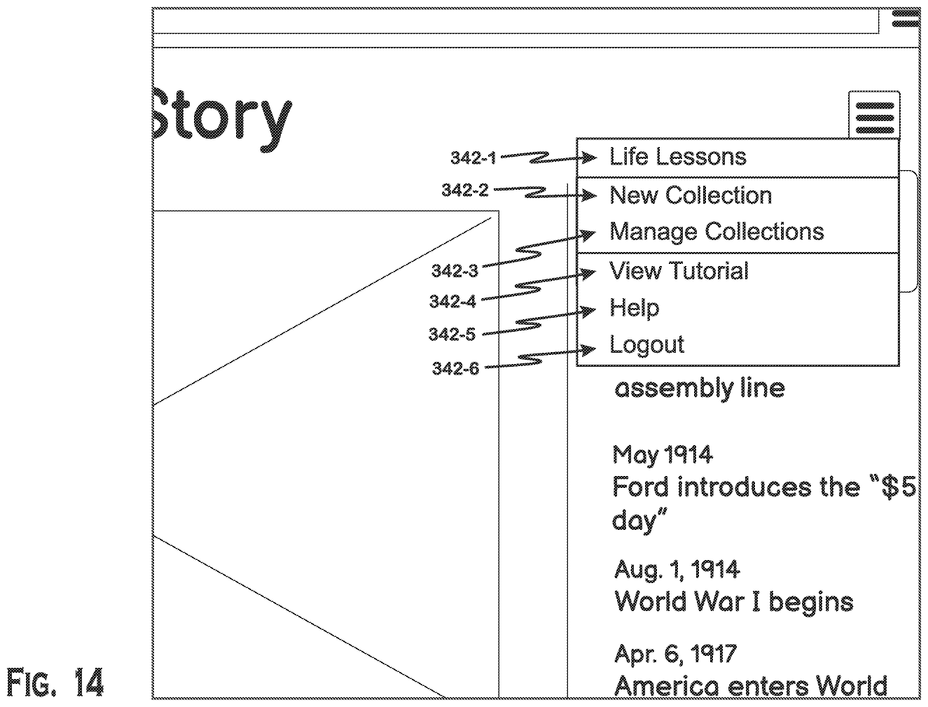

In the exemplary embodiment, the fixed element module 34 appears across the top of the display area and provides persistent site and user identification information as shown in FIG. 14.

The fixed element module 34 includes a digital archive title 341. The digital archive title 341 is positioned above the event record module 330. The digital archive title 341 further includes a menu icon 342 positioned next to the digital archive title 341.

The menu icon 342 includes a plurality of menu options 324-1. The plurality of menu options 342-1 includes a life lesson button 342-2, a manage collections module 342-3.

The plurality of menu options 342-1 further includes a view tutorial module 342-4; a help module 342-5 and a logout module 342-6. One skilled in the art would understand the applicant's design is not the exclusive embodiment.

The front end user:

As shown in FIG. 5 and FIG. 10, the four exemplary event summaries 321 displayed within the event timeline module, 32, represent records associated with the content filter 311D. Each displayed event summary 321 is presented in a distinct space within the event timeline module, 32, and listed in chronological order, with earlier display dates 323 at the top proceeding vertically downward toward later display dates 323 at the bottom. There is no limit to the number of event summaries 321 that can be selected for display by the event timeline module, 32 other than the total number of events that have been curated by the back-end user. The event summaries 321 may be scrolled up and down, as needed, by a front-end user FEU.

The front-end user FEU seeking further information related to the event summary, 321, selects that event summary by clicking on it within the event timeline module, 32. In response to this selection, the related event record module 330 with all of its associated content 331-338 is reported from the exemplary database for presentation in the event display module, 33. The selected event summary 321, is highlighted within the event timeline module 32 as a placeholder and aid to front-end user FEU navigation.

While consuming content from the displayed event 330 within the event display module 33 an exemplary front-end user FEU may also continue to scroll through and consider selections from the content filter module 31 and the event timeline module 32. The front-end user FEU selects a new event summary 321 to examine by clicking on it within the event timeline module 32 the newly selected event record module 330 with all of its associated content 331-338 will be reported from the exemplary database for presentation in the event display module 33. Moreover, should the front-end user FEU select or deselect other content filters 311 within the content filter module 31 by clicking on the associated content filter toggle switches 312 the associated event summary 321 will be added to or removed from the event timeline module 32 as appropriate to the underlying algorithms.

As shown in FIG. 14, the life lessons button 342-2 of the allows for the presentation of audio or video content that is not accessed by front-end user FEU through the content filter module 31 and the event timeline module 32. The use of the life lessons button 342-2 might include content that is not specific to a particular content category and/or that is not specific to a particular time or timeframe. Further instances might include content that is relevant to a plurality of content categories and/or that is relevant to a plurality of times or timeframes.

Referring to FIG. 14, in exemplary embodiment, the front-end user FEU accesses the life lessons module, 35, by clicking on the menu icon module, 341, of the fixed element module 34 and then clicking on the life lessons button 342-2. The front-end user FEU is then presented with a screen that is similar in appearance to the presentation of the content filter module 31, the event timeline module, 32, and the event display module 33 yet is different in the left and center columns.

The fixed element module, 34, is substantially unchanged in appearance and functions, with a key exception being that menu option 341-1 displays “Home” and is the means by which the front-end user FEU returns to the previously described presentations of the content filter module, 31, the event timeline module, 32, and the event display module 33.

In the exemplary embodiment, the front-end user FEU accesses the collections module 36 by clicking on the menu icon 342 of the fixed element module 34 and then clicking on the manage collections module 342-3, if they wish to go directly to creating a new collection, or by clicking on the manage collections module 342-3, if they wish to use the collection manager functions of the collections module, 36 as shown in FIG. 14.

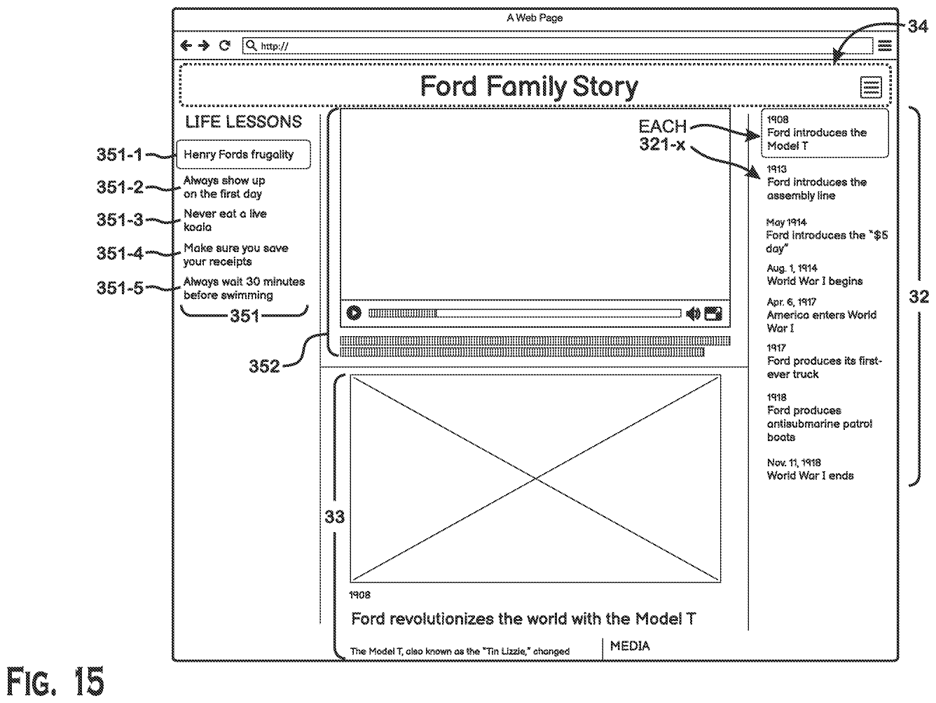

As shown in FIG. 15, in the left column an exemplary list of life lesson content 351 is presented showing content available for the front-end user FEU to select for consumption. In the exemplary embodiment of FIG. 15, five life lesson titles, each life lesson content 351, are shown as 351-1 through 351-5.

At the top of the center column is a media player frame 352, where exemplary video or audio content is displayed, along with the appropriate buttons for the front-end user FEU control of media file playback. In the right column is the event timeline module 32 which for the purposes of the front-end life lessons module 35 displays exemplary event summaries, 321, for any exemplary event records module 330, that have been linked to the specific life lessons content 351 by the back-end user.

In the center column, below the media player frame 352 is an exemplary version of the event display module 33, which presents the exemplary event content of the event records module 330 for any event summary 321 selected by the front-end user FEU from the event timeline module 32 is displayed in the right column as shown.

If no event records of the event records module 330 have been linked by the back-end user BEU to the life lesson content 351, the event timeline module 330 will be blank, having returned no event summaries 321 associated with the life lesson content 351 of the front-end life lesson module 35 selected by the front-end user FEU. The event display module 33 will also be blank.

In cases when event records of the event records module 330 have been linked to front-end life lessons module 35, the front-end user FEU will be able to consume all content associated with the event records module 330.

In the exemplary embodiment, collections of a collections module 36 differ from all other sets of event records in that collections are created by the front-end user FEU. All other designation and grouping of event records is performed by authorized back-end users BEU. Collections may also be shared among other front-end user FEU as chosen by exemplary front-end user FEU. Once created and/or shared, front-end user FEU access collections by using the content filter module 31.

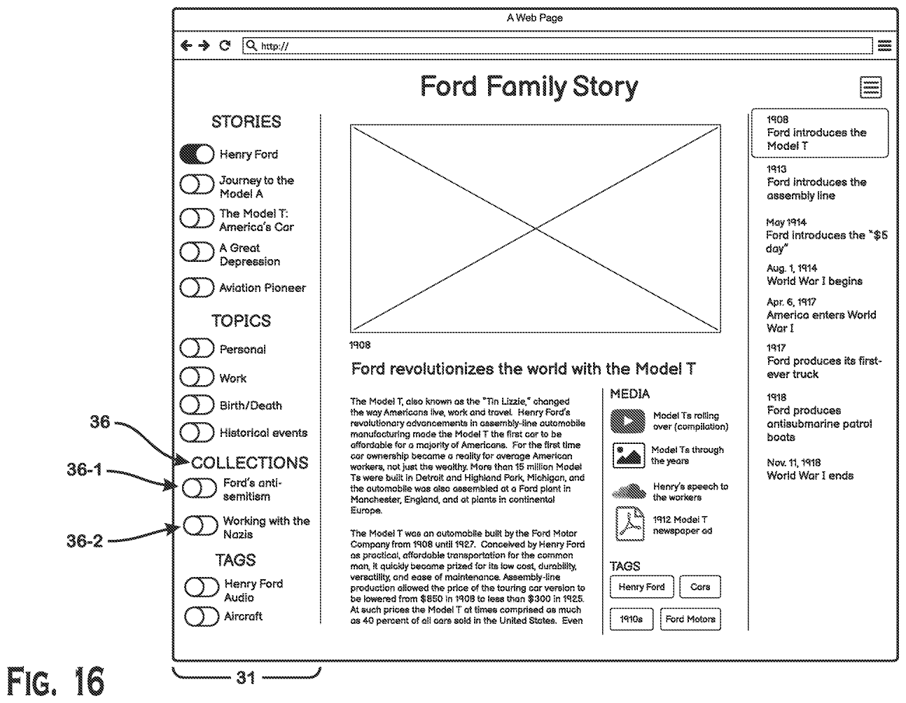

As shown in FIG. 16 collections module 36, appear as a distinct category within the content filter module 31 with individual collection titles 36-1 and 36-2, listed in the collections module 36. If an individual collection title 36-1, 36-2 is selected, the event summaries for the events associated with the selected collection category are displayed in the event timeline module 32 for the front-end user FEU to examine and consume. If a collection title 36-1, 36-2 is selected, all other event summaries are removed from the event timeline module 330. If a different content filter category is subsequently selected, the event summaries of the previous selected collection are removed from the event timeline module 330.

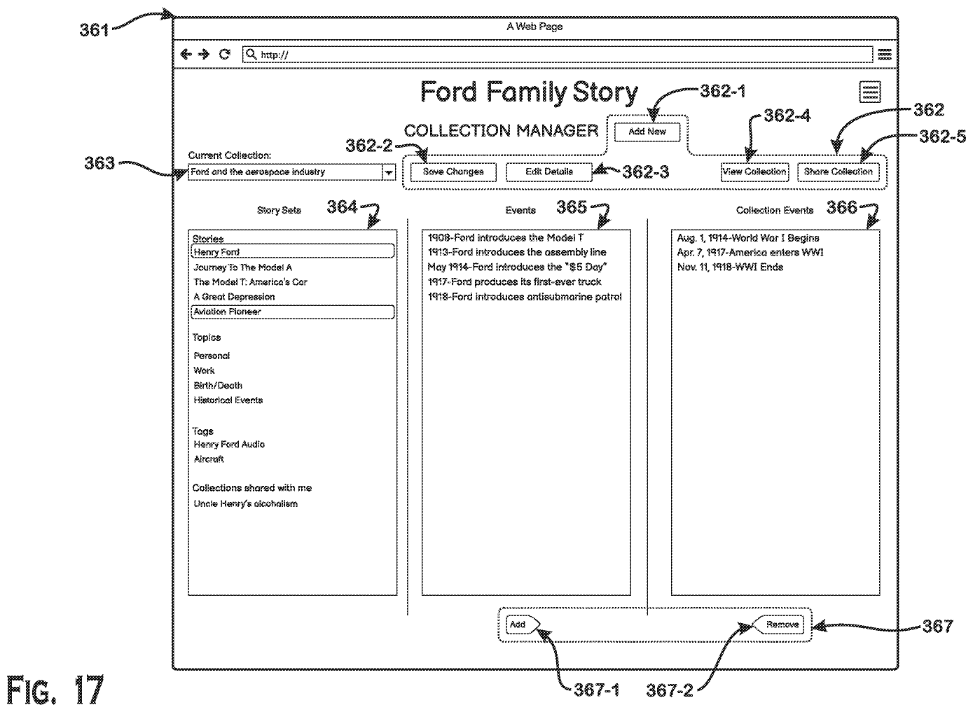

Referring now to FIG. 17, upon clicking the menu option for collection manager of the manage collections module 342-3, the front-end user FEU is presented with a collection manager module control screen 361 that includes near the top a set of control buttons 362. The collection manager of the collection module 36 control buttons 362 include functions for add new module 362-1, save changes module 362-2, edit details module 362-3, view collection module 362-4, and share collection module 362-5. To the left of the set of control buttons 362 is the collection selector, 363. The collection selector 363 which is a drop-down list containing the names of collections that have been created by, or shared with, an exemplary front-end user FEU.

Below the collection selector 363 and set of control buttons 362 are three vertical columns in the present embodiment. The left column is a display of story sets 364 which is a version of the content filter module 31 that shows the content categories.

As shown in FIG. 17, the center column is a display of events 365 which is a version of the event timeline module 32 that shows a list of display dates and display titles for events associated with content categories shown in 364.

As shown in FIG. 17, the right column is a display of collection events 366 which is a list of event display dates and display titles for events that have been selected by an exemplary front-end user FEU for inclusion in an exemplary collection for example by clicking the add new module 362-1.

Below the columns for the display of events 366 and the display of collection events 365 are control buttons 367 that the front-end user FEU employs to Add, using button 367-1, exemplary titles among the available event summaries listed in the display of collection events 365 to the collection of events 366 or to Remove, using button 367-2, exemplary event titles from an exemplary collection of events 365.

In the exemplary embodiment, the functionality for creating/adding a new collection may be accessed by the front-end user FEU either by using the menu icon 342 and selecting new collection in the manage collection module 342-3 or by selecting the add new module 362-1 from the top of the collection manager screen, 361.

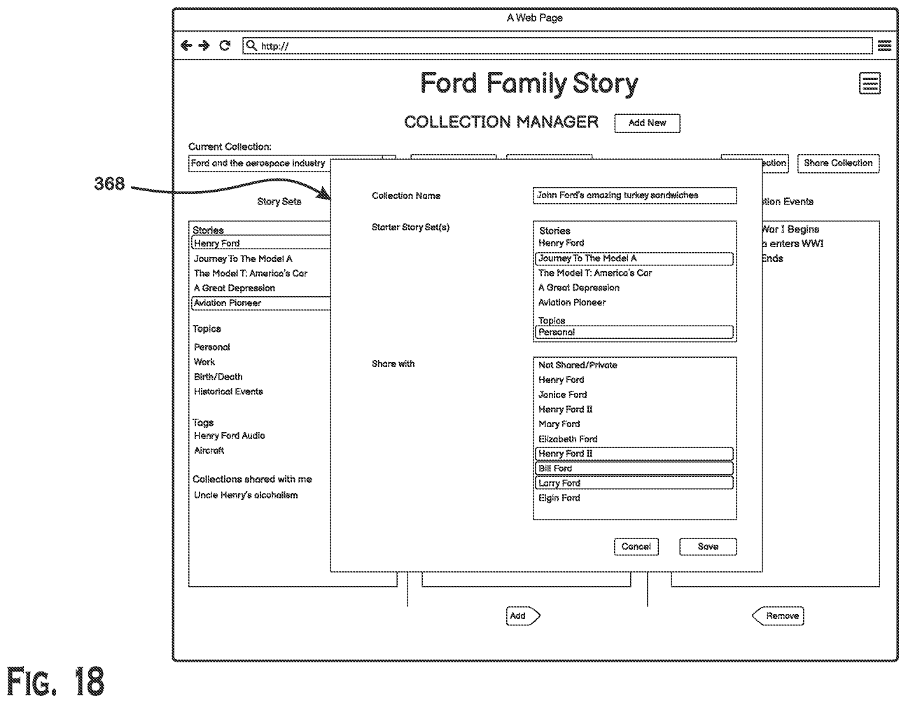

As shown in FIG. 5 and FIG. 18, the front-end user FEU is presented with the new collection modal, 368, which is used to create a name for a collection, select initial content filters 311A-E from which events may be chosen for inclusion in the new collection modal 368, and select other users with whom to share the new collection modal 368. After saving their selections, the front-end user FEU is taken to the collection manager module control screen 361 to assemble their new collection of events.

With respect to managing existing collections, the front-end user FEU uses the collection selector 363, to choose a collection title from an exemplary drop-down list. Any changes made are saved using the save changes module 362-2.

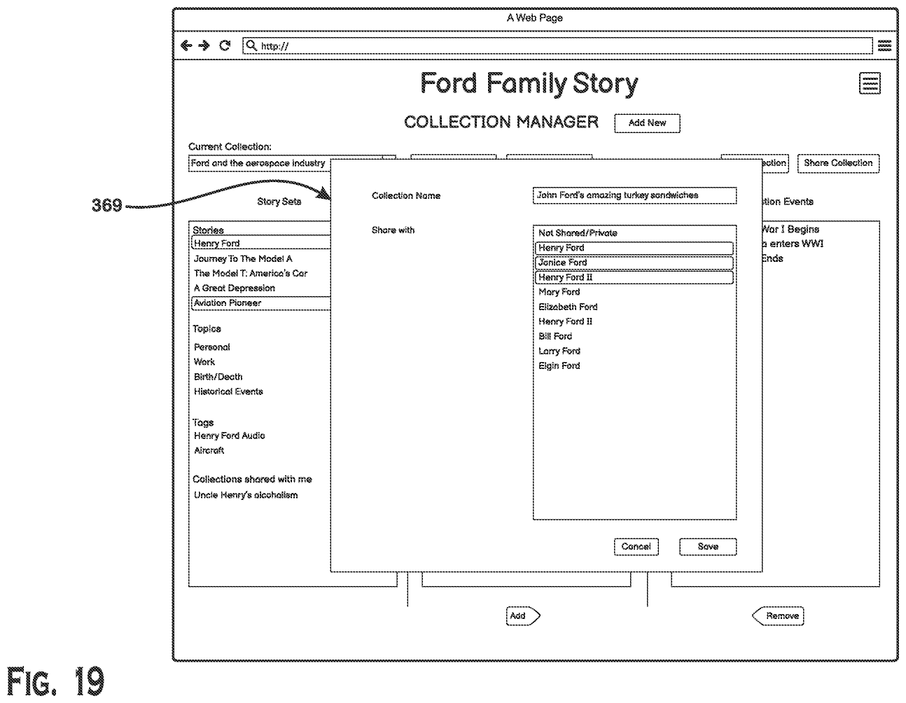

With respect to sharing collections, the front-end user FEU has the option of selecting the names of other users of the exemplary instance of the invention first when creating a new collection and at any time afterwards by using the edit details module 362-3 which presents the details modal 369, as shown in FIG. 19.

In either case, after selecting the names of other users, the exemplary front-end user FEU uses the share collection module 362-5, to complete the sharing function and notify the other users by email that a collection has been shared with them. While assembling or editing a collection the front-end user FEU may choose to view the collection as a set by choosing the view collection module 362-4, to open the collection in a separate tab of their browser.

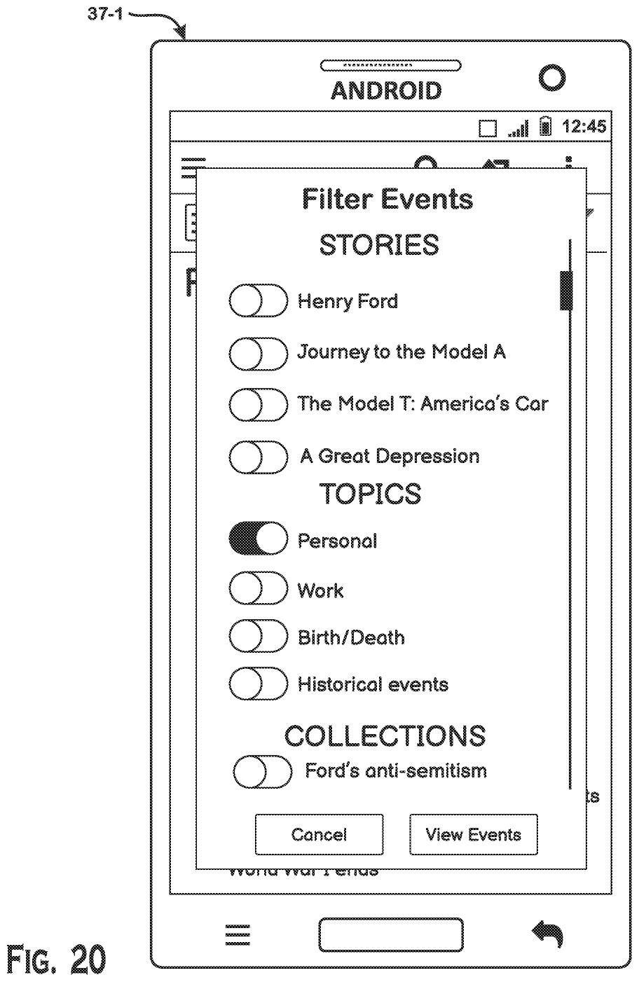

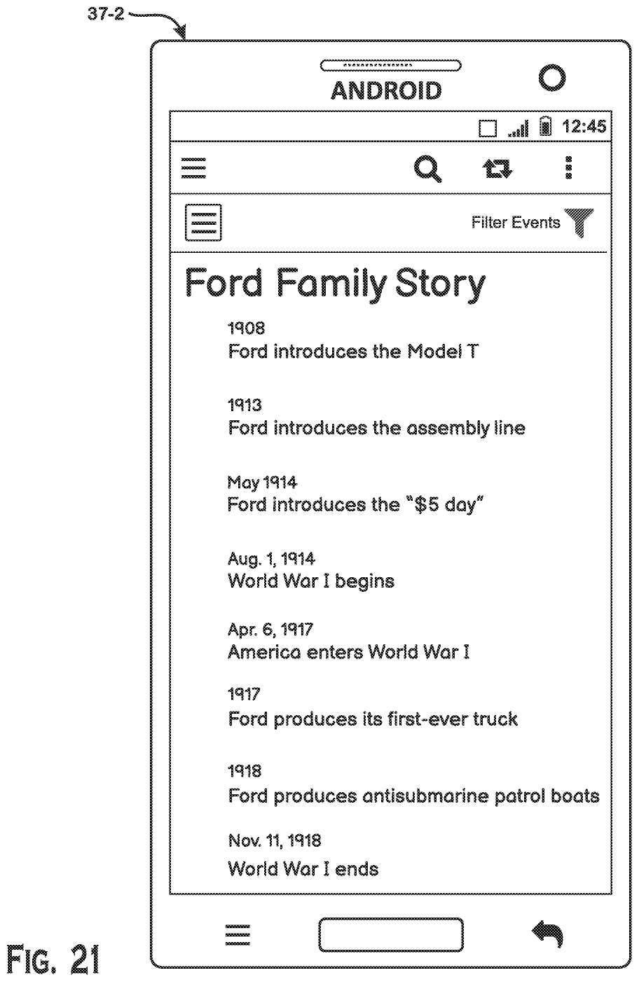

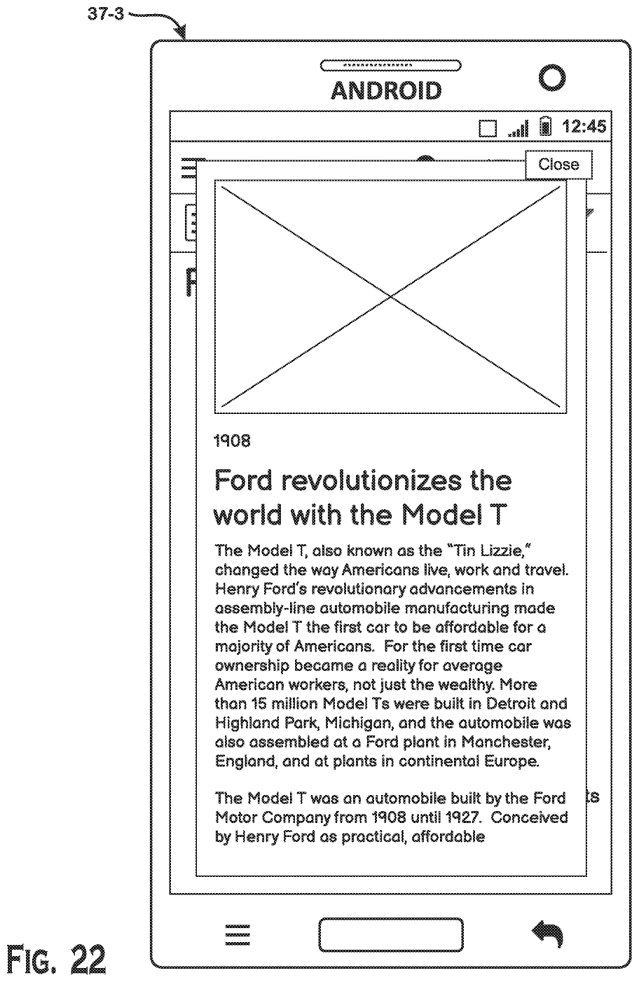

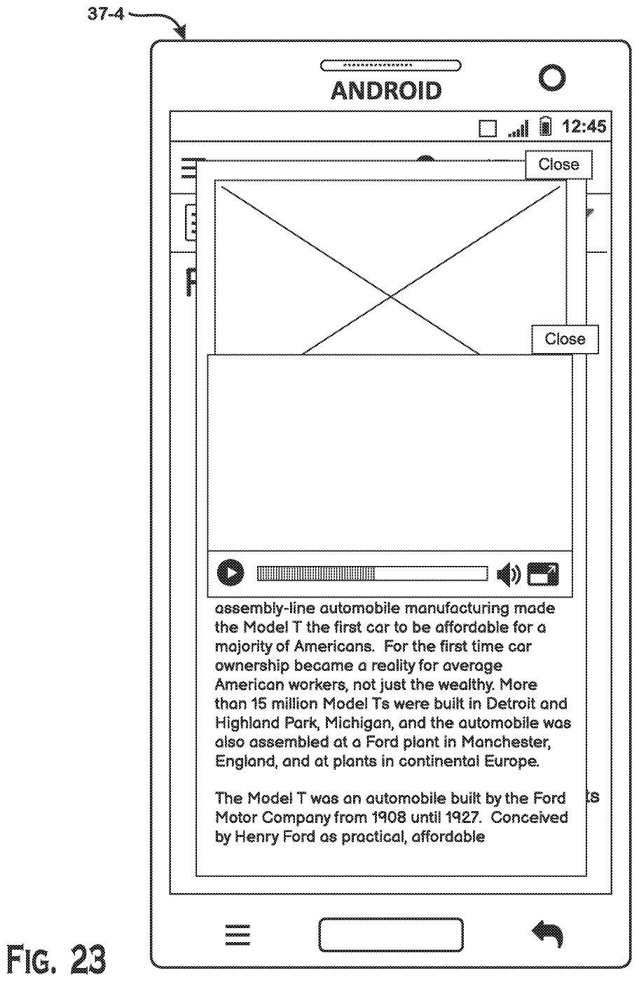

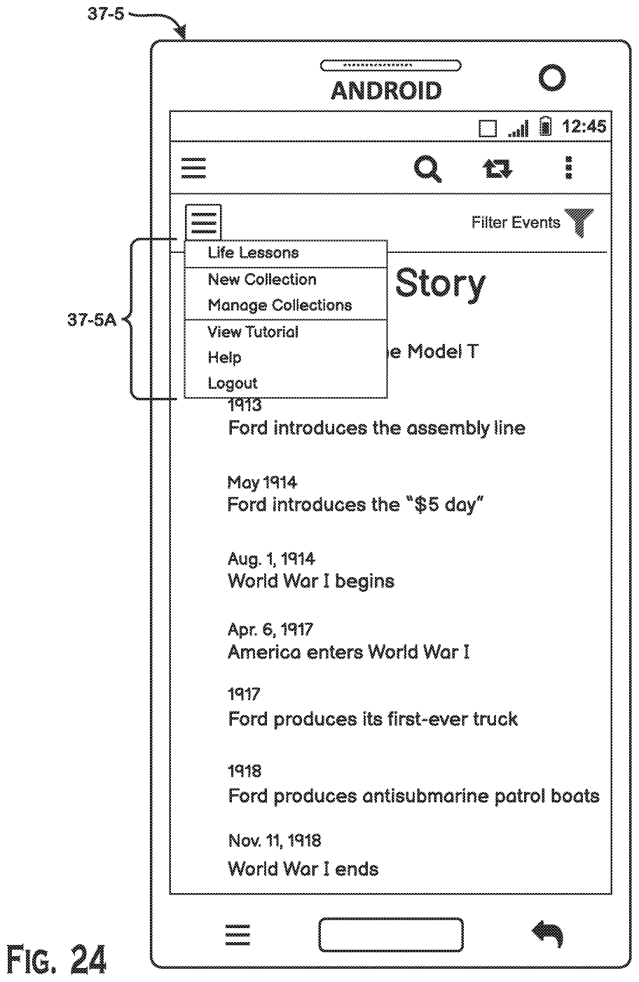

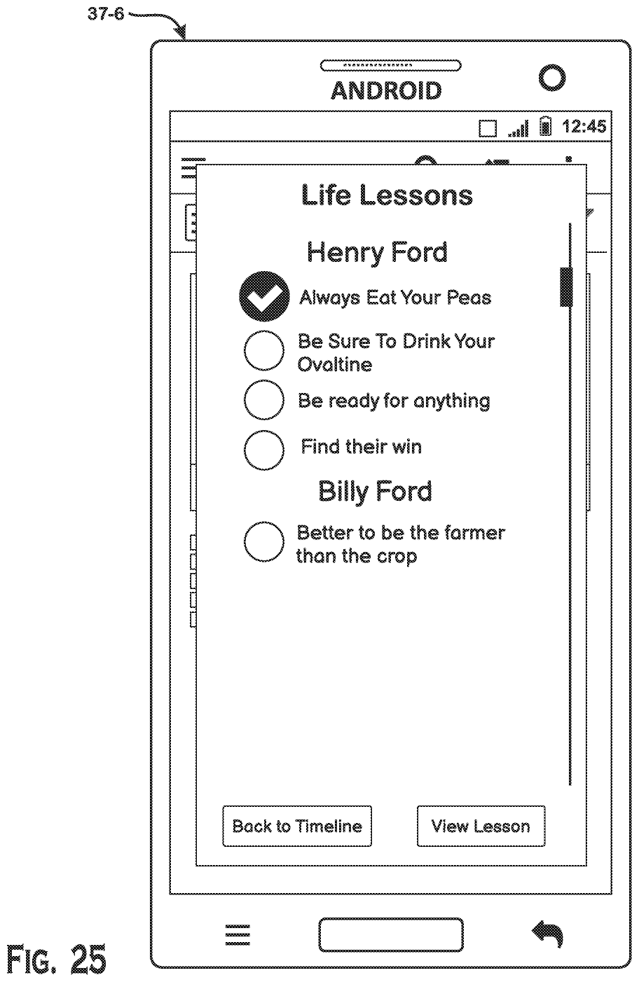

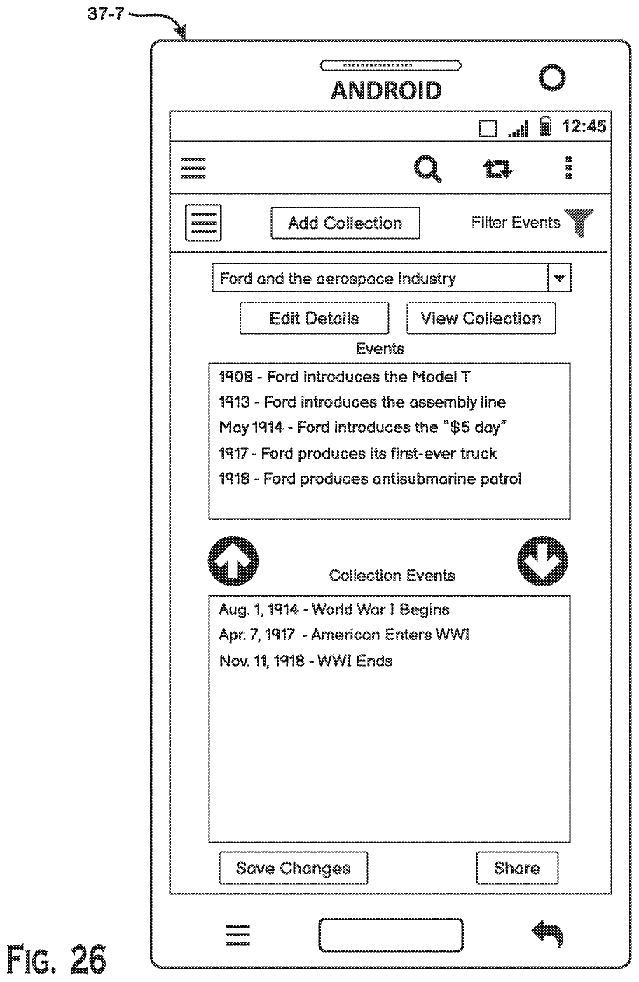

With reference to FIGS. 22-26, a mobile version of the invention application, 37, will be shown to all users whose browser window is less than 800 pixels wide. In the present embodiment, the exemplary mobile view is optimized for portrait orientation. Devices in landscape mode under a certain exemplary pixel width will present a black screen to the user with instructions to reorient their devices to a portrait view as shown in FIGS. 20-26. One skilled in the art would understand the applicant's design is not the exclusive embodiment.

FEU The back-end user BEU, uses the content preparation module, (designated as 1Y on FIG. 1, hereinafter referred to as 10, and further described in FIG. 3) to gather, organize and create content for entry into the content management configuration, lx, and more specifically into the back-end user BEU interface, 20, (which will be further described in FIG. 3 as the event creation module 20).

As previously described the content preparation module 10 and the event creation module 20 embody the tools and processes by which exemplary back-end users BEU prepare and create exemplary content that they publish by means of the invention for consumption by exemplary front-end user FEU.

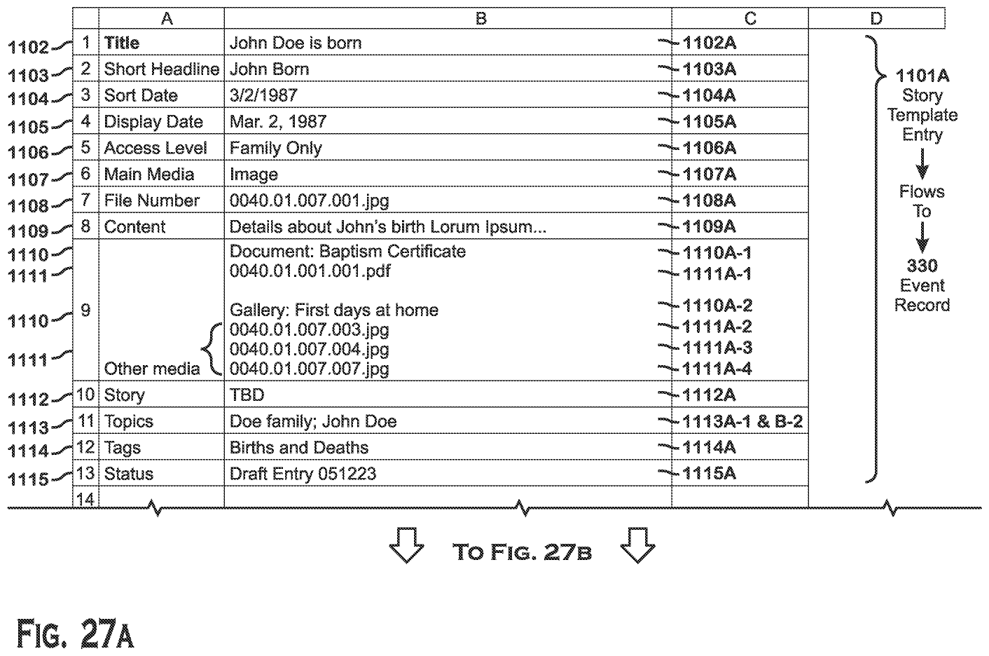

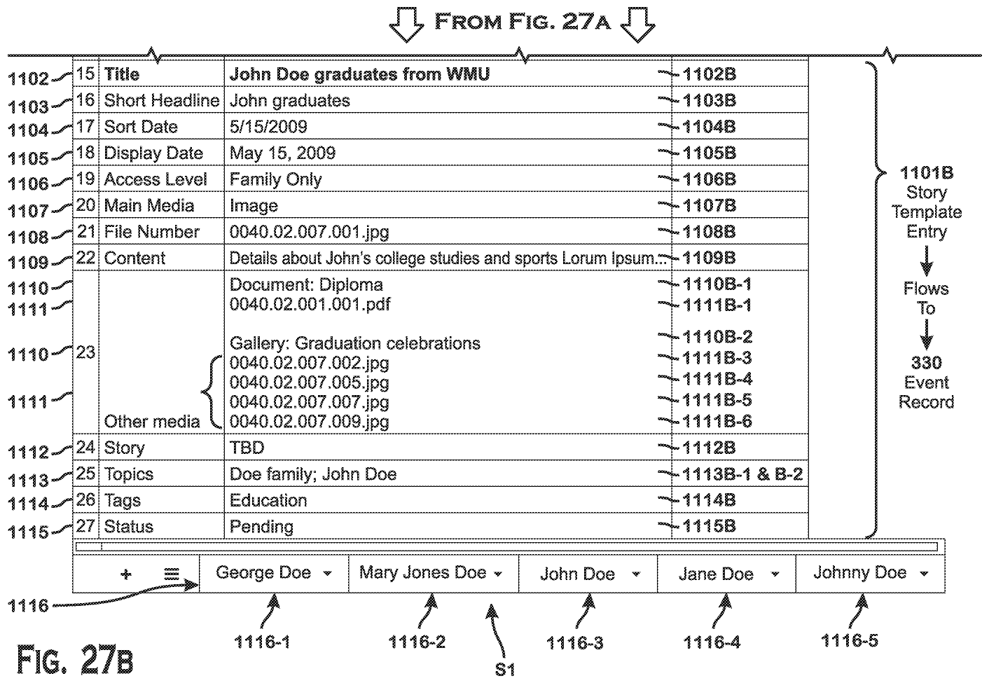

With reference to FIGS. 27-31, schematic diagram of exemplary databases for a back-end user environment of a timeline builder system according to the invention is shown.

As shown in FIGS. 27A, 27B hereinafter FIG. 27 a spreadsheet S1, illustrating the components of the story template module 11 within the content preparation module 10. The story template module 11 is a tool used for gathering, organizing and reviewing all of the component data elements of an event record module 330 and further, to organize and review exemplary sets of events for thematic coherence and quality of narrative flow, prior to uploading the component data elements into an exemplary instance of the invention.

Effective use of the story template module 11 speeds workflow, improves output quality and keeps work in progress visible to exemplary back-end user(s) BEU working individually or as a team.

As shown in FIG. 27, an event record module 330 consists of a plurality of data elements, each of which is recorded within a database (a story template entry 1101).

The story template entry 1101 includes an event title 1102, a display title 1103, a sort date 1104, a display date 1105, an access level 1106, a main media file type 1107, main media file number 1108, content copy 1109, a plurality of other media file type(s) 1110, a plurality of other media file number(s) 1111, a story set(s) 1112, a plurality of topic(s) 1113, a plurality of tag(s) 1114, a status 1115. One skilled in the art would understand the applicant's design is not the exclusive embodiment.

For illustrative purposes of FIG. 27, two story template event entries 1101, are presented, 1101A and 1101B, respectively. Please note that while the exemplary data field names are numbered per the values above, the individual event component data elements in FIG. 27 are noted by the exemplary event suffixes A and B, respectively.

Further with respect to the exemplary embodiment, data elements 1102 through 1109, plus 1115, may only have single values, while data elements 1110 through 1114 may have multiple values within their exemplary data element categories.

The spreadsheet S1, further includes a plurality of tabs, 1116. The plurality of tabs 1116 appear horizontally across the bottom of FIG. 27, shown as 1116-1 through 1116-5. Additionally, the spreadsheet S1 associated with each tab 1116 can be used to gather, organize and review event data for different narrative storylines within an exemplary project instance. As shown in FIG. 27, tab 1116-3 is shown as the active spreadsheet.

In an exemplary embodiment of the invention, the media log 12, performs a set of functions that complement the story template module 11 as tools within the content preparation module 10.

In an exemplary embodiment of the invention, the media log 12, provides a set of means and methods. The media log 12 permits the gathering of content files, while keeping track of their original sources. The media log 12 further determines where and how to assign each content file to the event records module 330. The media log 12 assigns captions as appropriate to each content file. Prior to uploading files to an archive database, the media log 12 assigns unique file numbers to each content file, within a numbering structure determined by the back-end user BEU. Once the content files are uploaded to a database instance, each content file can be readily linked to the specific event records module 330, intended by the back-end user BEU.

The media log 12, is highly adaptable to the preferences and practices of the back-end users BEU—serving as a framework for addressing the key issues addressed above.

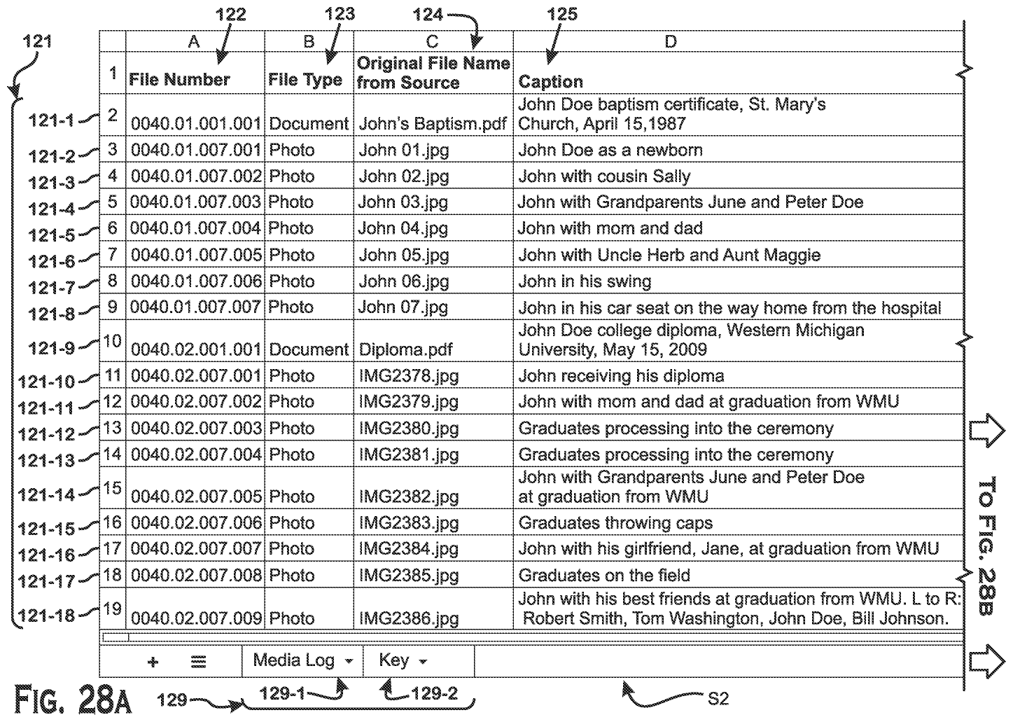

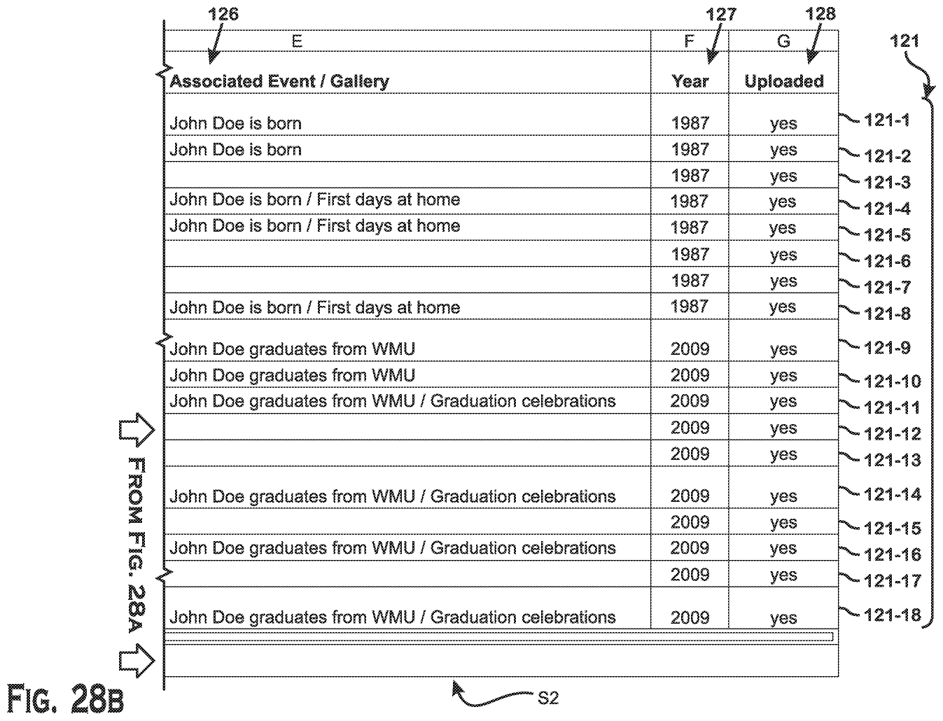

As shown in FIGS. 28A, 28B hereinafter FIG. 28, in an exemplary embodiment as a spreadsheet S2. One skilled in the art would understand the applicant's design is not the exclusive embodiment. The media log 12 includes a plurality of rows. Each row represents a content data file 121 As shown in FIG. 28 as a plurality of rows, 121-1 through 121-18. Each row further includes a column display descriptive elements. Each column displays key descriptive elements of each content data file listed in the rows.

Each column includes a unique file number assigned 122. Each column further includes a content file type 123. Each column further includes an original file name from source 124. Each column further includes a caption assigned 125. Each column further includes an associated event or gallery 126. Each column further includes a year 127. Each column further includes an upload status 128. One skilled in the art would understand the applicant's design is not the exclusive embodiment.

When used in conjunction with the story template module 11, the media log 12, allows the back-end users BEU to maintain unified control of all media assets intended for use.

The unique file numbers assigned 122 and content file types 123 are helpful inputs to the story template module 11 as they are critical data items used later when uploading story template event entries 1101, to an archive database.

The original file name from source 124, helps resolve editorial issues.

The listing assigned captions 125, ensures precise matching with unique file numbers, 122, during file uploading. Recording the back-end user BEU decisions about deployment of each content file 126, and event year 127, tracks file utilization.

Listing upload status, 128, helps manage workflow.

Lastly, within the exemplary embodiment of the spreadsheet S2 there are a plurality of tabs 129 shown as 129-1 and 129-2. As shown in FIG. 28, the active tab is the present media log 12.

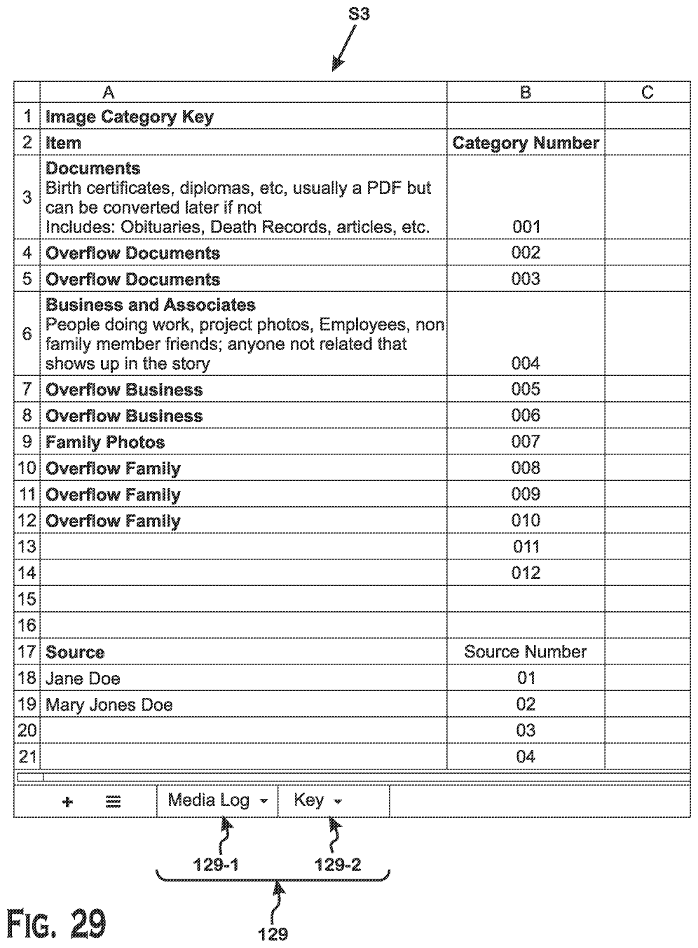

As shown in FIG. 29, in an exemplary embodiment as a spreadsheet S3, the tab 129-2 shows a key related to the unique content file number scheme shown on exemplary tab 129-1. The key of tab 129-2, aids consistent file processing by back-end users BEU, and may be modified as needed for any exemplary project. The key outcome is for each content data file 121 to be assigned the unique file number 122. The back-end users BEU has broad discretion to determine file numbering schemes to suit their purposes. The tab 129-2 serves to record and communicate an exemplary back-end user's BEU decisions.

In the exemplary embodiment, the event publication summary module 13, performs a set of functions that complement the story template module 11 and the media log 12 as tools within the content preparation module 10.

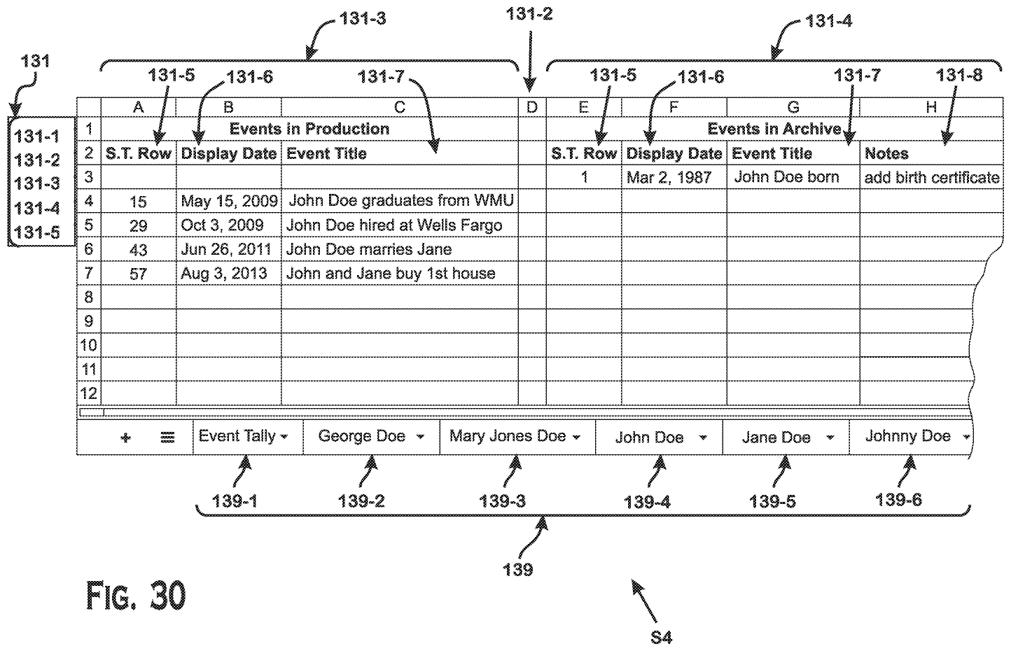

As shown in FIG. 30, in an exemplary embodiment as a spreadsheet S4. One skilled in the art would understand the applicant's design is not the exclusive embodiment.

In an exemplary embodiment of the invention, the event publication summary module 13 is within the content preparation module 10. Each row represents an exemplary event 131, within the event publication summary module 13.

As shown in FIG. 30, five exemplary event line items 131-1 through 131-5 are shown. Each column displays key descriptive elements of each event line item 131-1 through 131-5 listed in the rows. The column shows a vertical gray bar 131-2. The vertical gray bar 131-2 separates a set of columns to the left from a set of columns to the right of the vertical gray bar 131-2. To the left of the vertical gray bar 131-2, is a plurality of events in production set of columns 131-3. To the right of the vertical gray bar 131-2, is a plurality of events in the archive set of columns 131-4. The column further shows a story template row number 131-5. The column further shows an event display date 131-6. The column further shows an event display title 131-7. The column further shows a plurality of notes 131-8.

In the exemplary embodiment, the plurality of events in production set of columns 131-3, represents events in a plurality of states of development within the content preparation module 10, but prior to entry of content elements for any exemplary event into an archive database by means of the event creation module 20.

In the exemplary embodiment, the plurality of events in archive set of columns 131-4, represents events for which content elements have been entered into an archive database by means of the event creation module 20. Such events may continue to be in a plurality of states of development within the content preparation module 10, as noted by their status 1115, within the story template module 11. However, the key differentiator in this exemplary practice of the event publication summary module 13, is whether or not the event record module 330, exists within an exemplary database for consumption within the event display module 33, following its upload by the event creation module 20.

As shown in FIG. 30, within the plurality of events in production set of columns 131-3, are exemplary columns for data elements pertaining to events in development within the story template module 11, of the content preparation module 10.

As shown within the plurality of events in archive set of columns 131-4, are exemplary columns for data elements pertaining to events in a sufficient state of readiness to have been loaded into an exemplary instance of an archive, by use of the event creation module 20, and further corresponding to a recorded state of development within the story template module 11 of the content preparation module 10.

As shown in FIG. 30, the story template row number 131-5 shows the corresponding value of 1102 in FIG. 27. In the exemplary embodiment, the story template row number 131-5 is a column. One skilled in the art would understand the applicant's design is not the exclusive embodiment.

As shown in FIG. 30, the event display date 131-6 shows the corresponding value of 1105 in FIG. 27. In the exemplary embodiment, the event display date 131-6 is a column. One skilled in the art would understand the applicant's design is not the exclusive embodiment.

As shown in FIG. 30, the event display title 131-7 shows the corresponding value of 1103 in FIG. 27. In the exemplary embodiment, the event display title 131-7 is a column. One skilled in the art would understand the applicant's design is not the exclusive embodiment.

In the exemplary embodiment of the timeline builder system 1, upon entering the event record module 330 into an exemplary instance of an archive, via the event creation module 20, the back-end user BEU would cut and paste the data elements, from the corresponding row 131, from columns on the left of the vertical gray bar 131-2 within the plurality of events in production set of columns 131-3, and paste the data values into the columns on the right of the vertical gray bar 131-2 within the plurality of events in archive set of columns 131-4.

Further within an exemplary embodiment, the back-end user BEU might add information on the exemplary row 131-1 in FIG. 30, in the plurality of notes column 131-8, indicating further actions or data elements needed for the event record 330. Lastly, within the exemplary embodiment of the spreadsheet S4, tabs 131-9, appear horizontally across the bottom of FIG. 30, shown as 131-1 through 131-6. Accordingly, the spreadsheet S4 associated with each tab 131-9 can be used to gather, organize and review event data for different narrative storylines within an exemplary project instance.

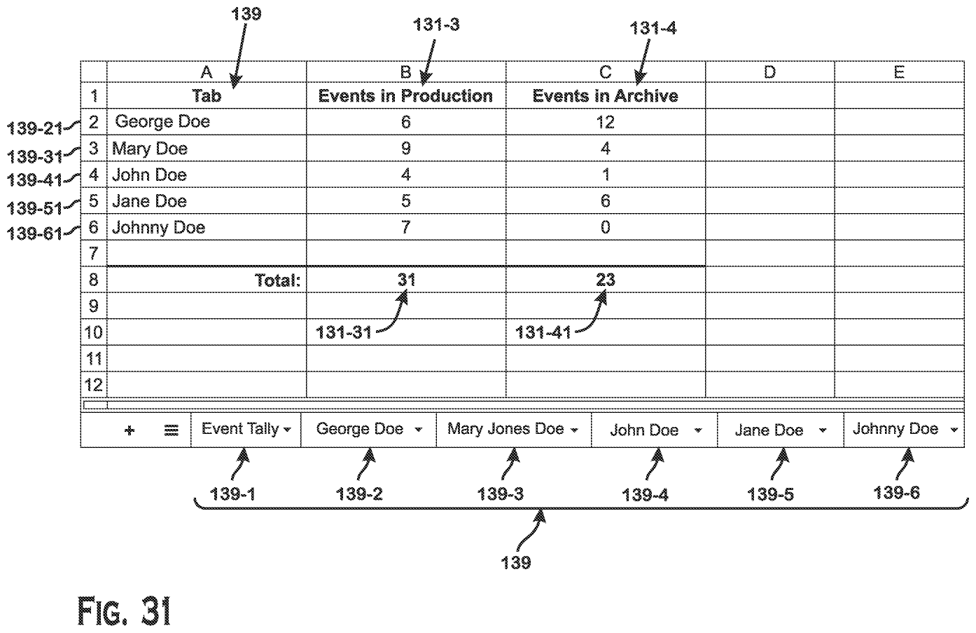

Referring now to FIG. 31, an exemplary tab 139-1 shows an exemplary tally of event quantities, detailed by one row per tab 139-21 through 139-61, with totals of the corresponding row values shown both for the plurality of events in production 131-3, plurality of events in production total 131-31, and a plurality of events in archive 131-4, a plurality of events in archive total, 131-41. Such exemplary tallies, 131-31 and 131-41, respectively, aid project planning and workflow control by exemplary back-end users BEU and may be modified as needed for any exemplary project.

As shown, when used in conjunction with the story template 11, and the media log, 12, the event publication summary 13, allows the back-end users BEU to maintain unified control of event development and publication within an instance of the invention.

In the exemplary embodiment, the back-end users could utilize the plurality of events in production set of columns 131-3, in conjunction with exemplary tabs 131-9, to draft title ideas and approximate dates, as part of developing draft narratives, in advance of populating the story template module 11 with the content components 1102 through 1115.

As the development of exemplary content proceeds, the back-end user BEU could transition into managing the flow of event development work-in-progress in an exemplary manner while keeping track of the quantities of event records.

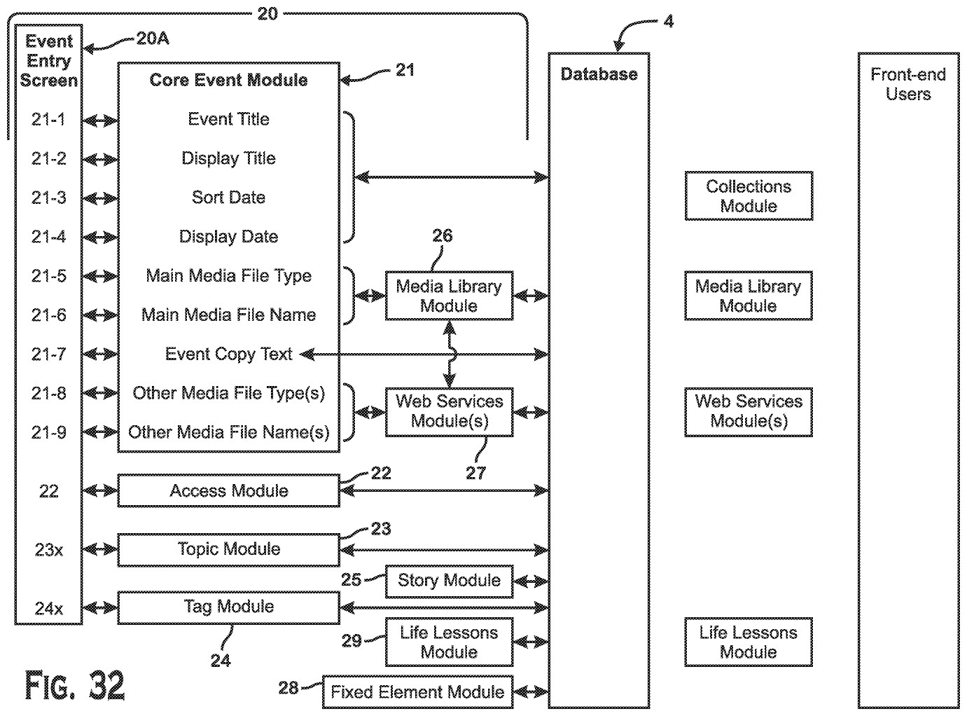

As shown in FIG. 32, a schematic diagram of the event creation module 20 which the back-end users BEU create and edit data for event records of the event records module 330 for subsequent consumption by the front-end users FEA within the event display module 33.

As previously stated, the event creation module 20 consists of the plurality of sub-modules 21-1 through 21-9, which are further illustrated in FIG. 32. The back-end user BEU enters and edits data and file content for an event in an event entry screen 20A.

In the exemplary embodiment, the event entry screen 20A contains a plurality of fields associated with the sub-modules 21. The plurality of fields includes a field 21-1 permits the entering and editing event titles within the core event module 21. The plurality of fields includes a field 21-2 permits the entering and editing display titles within the core event module 21. The plurality of fields includes a field 21-3 permits the entering and editing sort dates within the core event module 21. The plurality of fields includes a field 21-4 permits the entering and editing display dates within the core event module 21. The plurality of fields includes a field 21-5 permits the entering and editing main media file types within the core event module 21. The plurality of fields includes a field 21-6 permits the entering and editing main media file names within the core event module 21. The plurality of fields includes a field 21-7 permits the entering and editing event copy text within the core event module 21. The plurality of fields includes a field 21-8 permits the entering and editing other media file types within the core event module 21. The plurality of fields includes a field 21-9 permits the entering and editing other media file names within the core event module 21.

The access module 22 includes a field 22x. The field 22x permits the entering and editing user permission levels within the access module 22.

The topic module 23 includes a field 23x. The field 23x permits the entering and editing event topics within the topic module 23.

The tag module 24 includes a field 24x. The field 24x permits the entering and editing event tags within the tag module 24.

The core event module 21, the access module 22, the topic module 23, and the tag module 24 include direct access, via respective utilities apart from the event creation screen 20A, through which the back-end users BEU can enter and edit respective data per module within the event creation module 20.

As shown in FIG. 32, the event creation module 20, contains modules which enable the back-end users BEU to create and edit data for event records of the event record module 330 for which the back-end users BEU access the modules independently of the event creation screen, 20A.

As shown, the story module 25 provides an optional grouping of event records of the event records module 330 and to maintain the identities of such sets within an exemplary instance of a database 4, whereby the back-end user BEU may designate a story of the plurality of stories 315 of the event records module 330, to present as grouping with its own content filter, 311, for selection within the content filter module 31 even though the constituent event records of the plurality of stories 315, may be associated with dissimilar Topics, 313, and/or Tags, 314.

As shown, the media library module 26 permits the entering and editing of media files, specifically: individual images, galleries of multiple images, document, and audio files, and storing such files within an exemplary instance of a database 4.

As shown, the web services module 27 permits invoking access to a plurality of web services, which serve a plurality of functions related to rendering, and in some cases, hosting by third parties, for a plurality of content file types and related functionality. In the exemplary embodiment, the web services module 27 is maintained programmatically by system administrators and is not edited by back-end users BEU.

As shown, the fixed element module 28 provides functionality that enables the back-end users BEU to switch between the back-end and front-end functions of an individual exemplary site. Additionally, the fixed element module 28 provides shortcuts for the back-end users BEU to navigate quickly among exemplary back-end modules, and to move from one exemplary site to another exemplary site in situations when the back-end user BEU possesses the required user privileges for multiple sites.

The back-end life lessons module 29, permits back-end users to present audio or video content media content for consumption by front-end users that is not accessed by using an exemplary site's content filter module 31 and the event timeline module 32. Exemplary uses of this feature might include content that is not specific to a particular content category and/or that is not specific to a particular time or timeframe. Further exemplary instances might include content that is relevant to a plurality of content categories and/or that is relevant to a plurality of times or timeframes.

As shown in FIG. 32, an exemplary database 4, serves as a repository for all content files entered via an event entry screen 20A, and the modules 21 through 29 described above, within the event creation module 20. Further to the descriptions of modules 21 through 27, in the exemplary embodiment, all fields in module 21, 21-1 through 21-9, and module 22 are restricted to single value entries within the event creation module 20.

Field 21-3, Sort Date, must be entered in a specific format, which then allows an absolute chronological sequence to be established among the entire plurality of event records in an exemplary instance of an archive database. In the present embodiment, such absolute chronological sequence underlies the module interactivity.

Field 21-5, Main Media File Type, presents a drop-down list of content file types that are acceptable for display within the main media frame 331 in FIG. 6. In the exemplary embodiment, the acceptable file types are individual images, galleries of multiple images and video files.

Field 21-6, Main Media File Name, requires a unique identifier so that a specific content file may be reported from an exemplary database, 4, for display in the main media frame 331 in FIG. 6.

Field 21-7, Content Copy Text, may be composed by an exemplary back-end user within the Event Entry Screen, 20-A, or may be copied and pasted from any other source. In the exemplary embodiment, in order to optimize throughput, exemplary back-end users are encouraged to compose and edit copy using content copy 1109 within the story template module 11, then subsequently to copy and paste text from the story template module 11 into the event entry screen 20A. Event copy is subsequently displayed in an exemplary copy frame 335 in FIG. 6.

Field 21-8, Other Media File Type, presents a drop-down list of content file types that are acceptable for display within other media modals 337 in FIG. 6. In the present embodiment, acceptable file types are individual images, galleries of multiple images, documents, audio, video, HTML and download file types.

Field 21-9, Other Media File Name, requires a unique identifier so that a specific content file may be reported from an exemplary database, 4, for display within the other media modal 337. Such exemplary databases, 4, may be hosted by third parties and invoked using a plurality of web services within the web services module 27 thereby rendering an exemplary content file using the functionality of a corresponding web service.

In the exemplary embodiment, access module 22, permits the user to have access privileges to content based on an exemplary hierarchy of permission levels, which are assigned per user or user group by exemplary back-end users. The access module 22 provides a filter at the level of individual event records of the event records module 330 that either allows or prevents the reporting of exemplary individual event summaries 321 within the timeline module 32.

For an exemplary front-end user FEU with insufficient access permission for the event record of the event records module 330 the associated event summary 321 will not appear in an exemplary timeline display regardless of the exemplary front-end user's selections within the content filter module 31, thus making the exemplary event record unavailable for display within the event display module 33 for the front-end user.

In the exemplary embodiment, the topic module 23 are required data elements for the event record of the event record module 330 which in conjunction with the sort dates 21-3, underlie the topic module 23 interactivity Topic of the topics module 23, are determined in the present embodiment by back-end users and input 23x, are means by which front-end user selections of content filters 311, cause event summaries 321, to be reported from an exemplary database 4 for display within the timeline module 32.

In the exemplary embodiment, the tags module 24 are optional data elements for an exemplary event record of the event records module 330, which in conjunction with sort dates 21-3, underlie the tags module 24 interactivity. Tags of the tags module 24, are determined by the back-end users BEU as and input 24x, the front-end user selections of content filters 311, cause event summaries 321, to be reported from an exemplary database, 4, for display within the timeline module 32.

In the exemplary embodiment, the story module 25 are optional data elements for an exemplary event record of the event records module 330, which in conjunction with exemplary sort dates, 21-3, underlie the story module 25 interactivity. Stories of the story module 25, determined in the present embodiment by the back-end users and input 25x, permit the front-end user selections of content filters 311, cause event summaries 321, to be reported from an exemplary database, 4, for display within the timeline module 32.

In an exemplary embodiment, the story module 25 provides back-end users BEU to create a story filter name 311, and to select event records 330, from among all event records in an exemplary instance of an archive which will identified within the database 4, as constituent events of the exemplary story set. The exemplary story set name will be presented within the content filter module 31 as an option for front-end user selection under stories 315. If selected, the constituent event summaries 321, of the event records of the event records module 330, will display in the event timeline module 32, subject to the user permission level for the exemplary front-end user, per event record of the event records module 330, as recorded in the access module, 22.

In an exemplary embodiment, media library module 26 are components of narrative presentation deployed by exemplary back-end users BEU to enhance the experience of exemplary front-end users FEU. Exemplary media files that may be housed in an exemplary media library, within an exemplary database 4, include individual images, galleries of multiple images, documents and audio files.

In the exemplary embodiment, exemplary back-end users BEU may also choose to access each of these exemplary media file types through a utility that provides a direct means of access, within the event creation module 20 apart from the event creation screen 20A. Exemplary media files within an exemplary media library module 26, when selected by an exemplary front-end user FEU, will be rendered using a plurality of associated web services, appropriate to the exemplary media file type, via the web services module 27.

For exemplary individual images, exemplary back-end users BEU may include caption text as part of an individual image record, in which case, an exemplary associated caption will display under the exemplary associated image whenever it is displayed. If an individual image is deployed within a main media frame 331, an associated caption is displayed in a main media caption frame 332. If an individual image is deployed as another media link 336, an associated caption is displayed within an other media modal 337, as shown in the exemplary embodiment of the other media modal in FIG. 12. Also, galleries of multiple images convey captions per image. One skilled in the art would understand the applicant's design is not the exclusive embodiment.

In the exemplary embodiment, web services modules 27 are managed in the web services module, 27, and are associated with exemplary media file names, 21-6 and 21-9, based on exemplary back-end user designations of exemplary media file types, 21-5 and 21-8, respectively when exemplary back-end users BEU designate exemplary media files of the media library module 26, for use within an event record via the core event module, 21. For exemplary individual images, galleries of images, document file types, the exemplary web services associated per file type in a main media frame, 331 other media modal 337 provide exemplary front-end users FEU with exemplary functionality such as zoom, pan, scroll, etc.

For exemplary audio media files, the exemplary web services associated with the exemplary file type provide user controls appropriate for the exemplary file type across the bottom of an exemplary display within the narrative display module 30.

For exemplary media file types such as video, HTML and downloads, the exemplary web services associated per file type in a main media frame 331 or other media modal 337 provide exemplary front-end users FEU with exemplary functionality such as access to files hosted by a plurality of third parties plus appropriate front-end user FEU controls for the exemplary associated file types.

In the exemplary embodiment, the back-end life lessons module 29 provides back-end users to create a life lesson title 351, and to select exemplary media files from the media library module 26, or web service module 27, from among all media files in an exemplary instance of an archive, which will identified within the database, 4, as constituent media files of the exemplary life lesson 351.

The life lesson name of the life lesson 351, will be presented within the exemplary list of life lessons 351, as an option for front-end user selection, within the front-end life lesson module, 35. If selected, the exemplary media file will be presented for consumption within the associated media player frame 352.

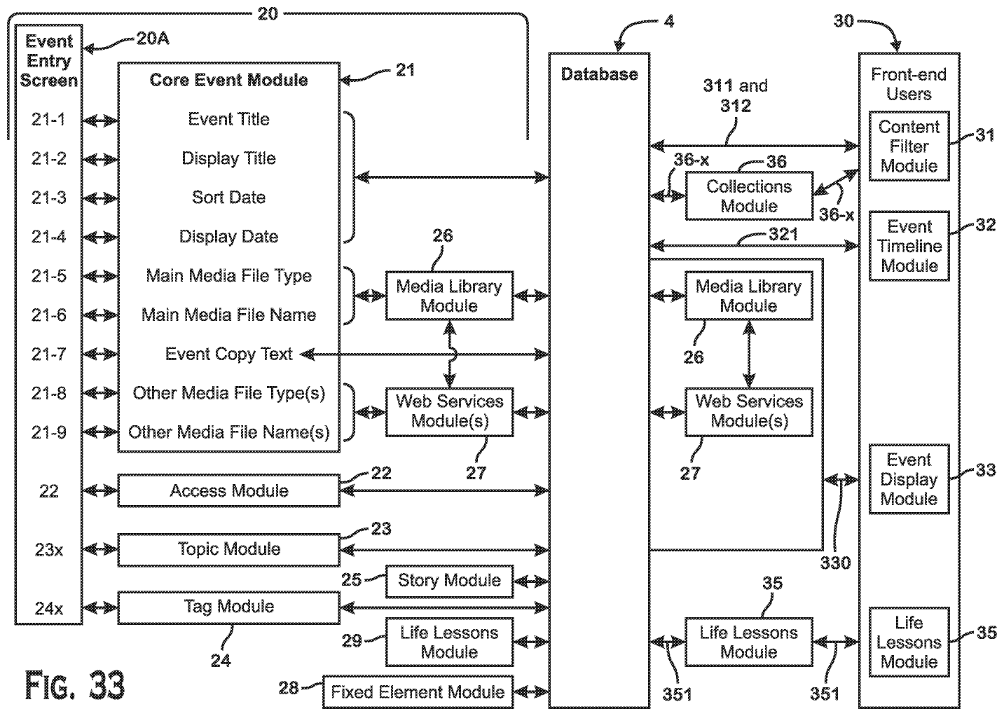

As shown in the exemplary embodiment, the interactivity of back-end users BEU and front-end users FEU is in FIG. 33. In an exemplary embodiment, FIG. 33, builds on FIG. 32, as a schematic representation of interaction of the back-end event creation module 20 with the front-end narrative display module 30.

Exemplary front-end users utilize the content filter module 31, to examine the content filter 311, and collection names 36-x.

Exemplary front-end users FEU choose among exemplary options by selecting exemplary toggle switches 312, which reports the options chosen to an exemplary database 4.

The event summaries 321 are reported from the database, 4, to the event timeline module 32 which displays the reported event summary records in chronological order, according to the exemplary sort date 21-3, associated with each event record of the event record module 330.

The event summaries 321, reported within the event timeline 32, will only be those for which the front-end user FEU has sufficient permission, according to the required permission level recorded within the access module 22 for each exemplary event record 330.

Exemplary front-end users FEU utilize the event timeline module 32 to examine the reported event summaries 321 by viewing event summary display titles 322 and display dates 323 which have been entered from the back-end as 21-2 and 21-4.

Exemplary front-end users FEU choose among the exemplary options presented by clicking an exemplary event summary 321 which reports the option chosen to the exemplary database, 4.

The selected exemplary event record of the event records module 330, is reported from the database, 4, to the event display module 33 which renders all of the content associated with the selected event that has been entered into the database by exemplary back-end users BEU via the exemplary event creation module 20 and its exemplary component modules, as depicted in FIG. 33.

Exemplary front-end users FEU utilize the front-end life lessons module, 35, to examine exemplary life lesson names of the life lesson 351 and to select among exemplary options by clicking a name of the life lesson 351 which reports the option chosen to the exemplary database, 4.

The media file associated with the selected life lesson 351 which has been entered by the back-end user via a back end life lesson module, 29, is reported from the database, 4, for rendering within the front-end life lessons module 35 along with exemplary event summaries, 321, that are associated with the life lesson 351 displayed in a version of the timeline module 32, that is contained within the front-end life lesson module, 35.

FIG. 32 and FIG. 33 illustrate an exemplary embodiment of the interactivity of the event creation module 20 and the narrative display module 30,

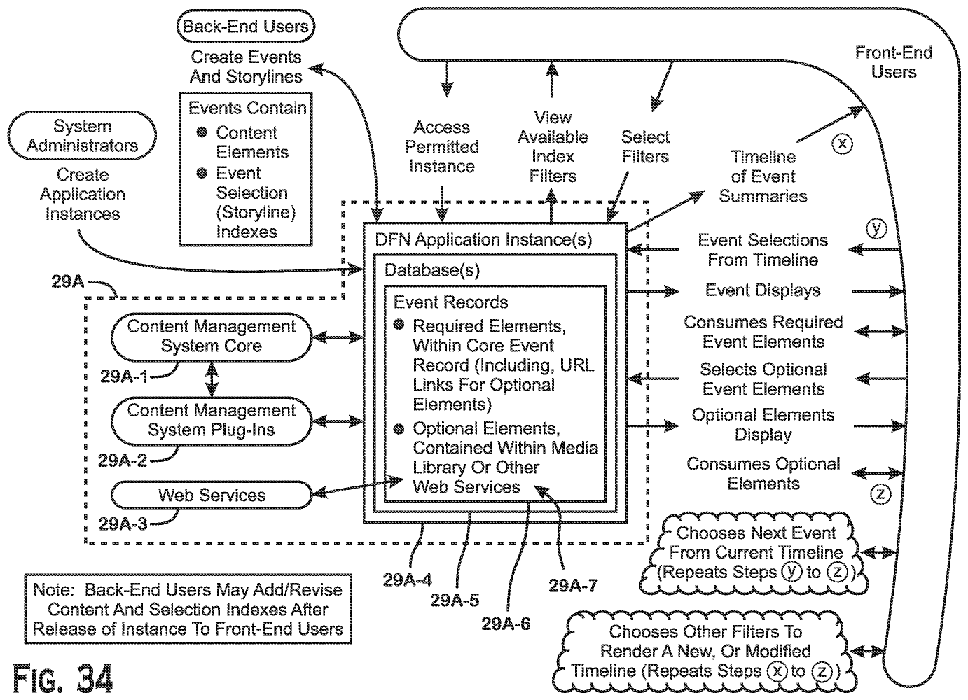

As shown, FIGS. 34-37 are schematic representations of the interactivity of all modules in the present embodiment.

In the exemplary embodiment, FIG. 34 is a schematic representation of an exemplary content management system 29A consisting of a content management system core 29A-1, a set of content management system plug-ins 29A-2 and a set of web services 29A-3.

As shown, the content management system core 29A-1, the set of content management system plug-ins 29A-2, and the set of web services 29A-3 interact in an exemplary manner that provides exemplary instances of the content management application 29A-4 of the timeline builder system 1.

In the exemplary embodiment, each exemplary instances of the content management application 29A-4 may include a plurality of databases 29A-5. Further within each database 29A-5, may be located a plurality of event records 29A-6 each containing a plurality of data elements 29A-7.

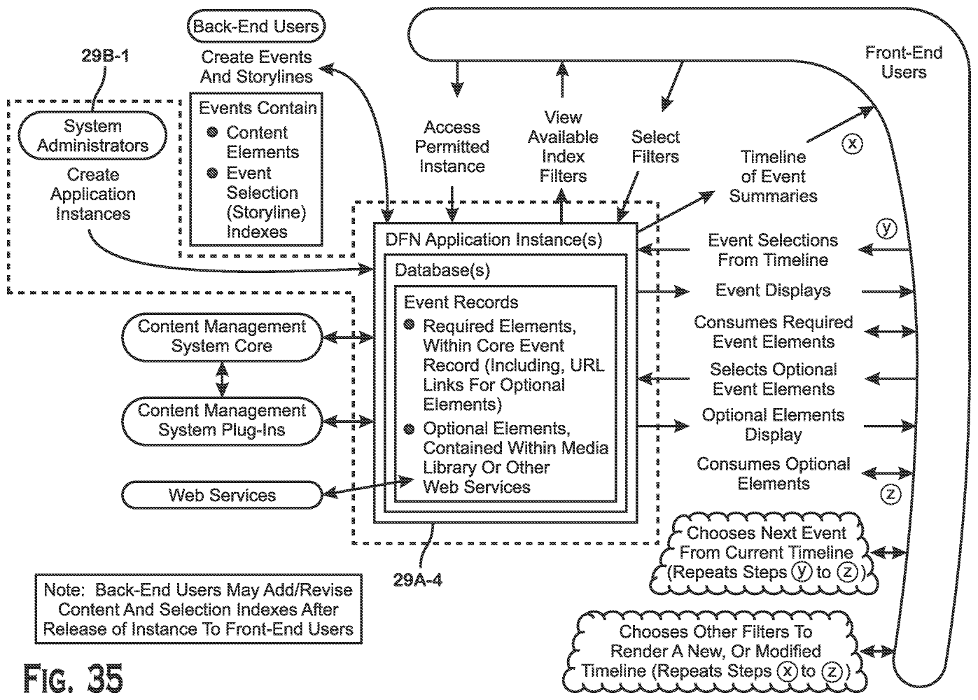

In the exemplary embodiment, FIG. 35 is a schematic representation of an exemplary content management system 29A under management by a plurality of system administrators 29B-1 who provide instances of the content management application 29A-4 to the plurality of back-end BEU and front-end users FEU.

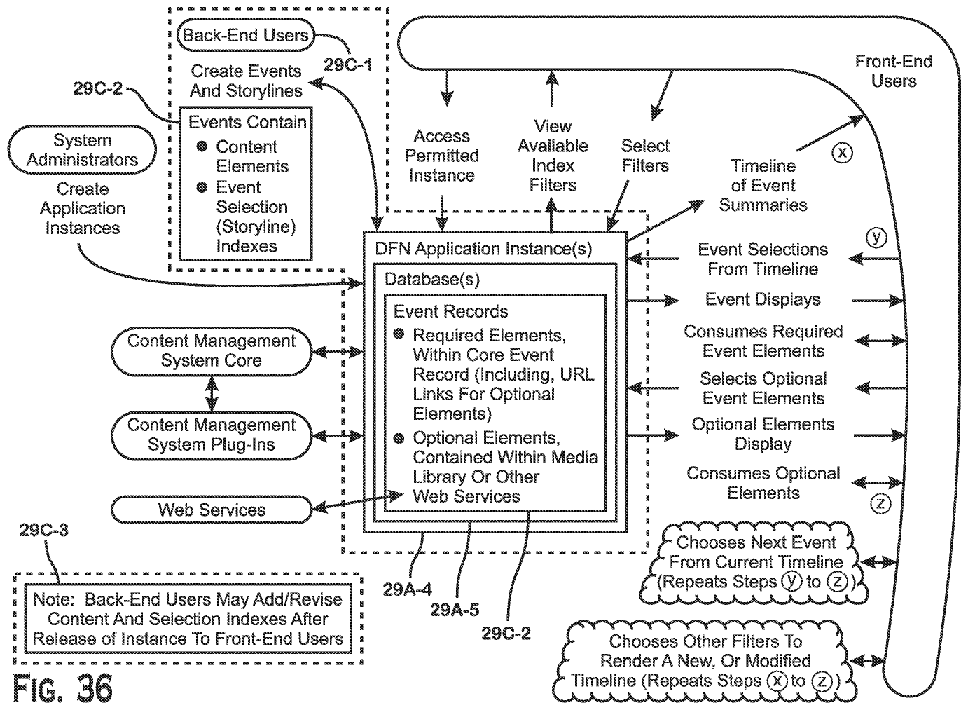

In the exemplary embodiment, FIG. 36 is a schematic representation of the content management system instance 29A-4 as used by the plurality of back-end users 29C-1 who enter content 29C-2 into the instance of the content management application 29A-4 and its exemplary databases 29A-5. As noted, 29C-3, exemplary back-end users 29C-1 may continue to add and revise content, as well as add and revise content filters (selection indexes), after the release of an exemplary instance to front-end users FEU. One skilled in the art would understand the applicant's design is not the exclusive embodiment.

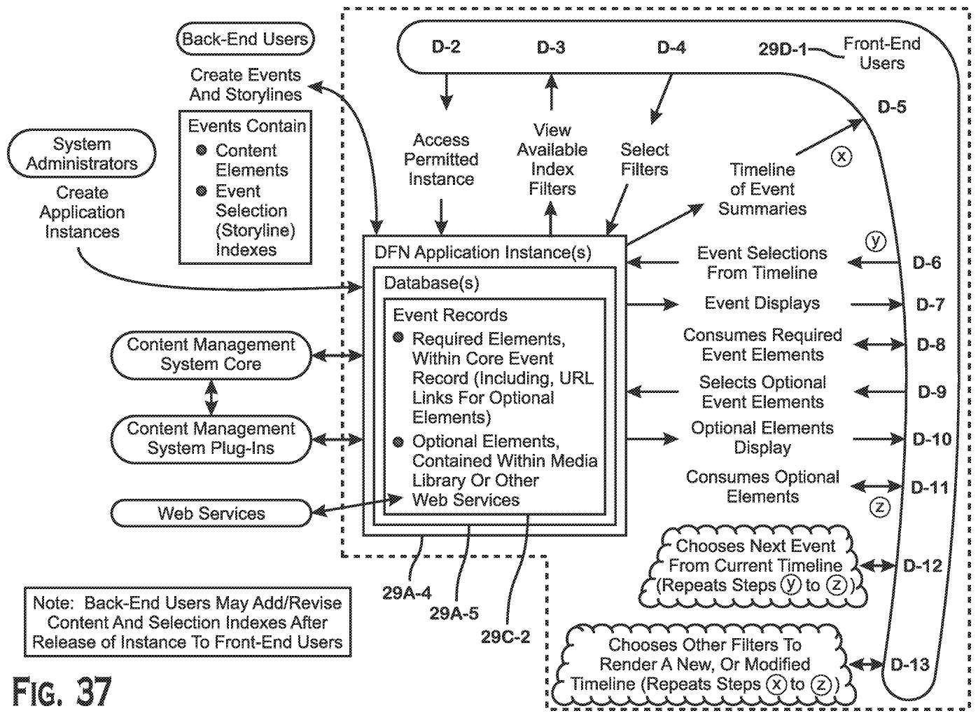

In the exemplary embodiment, FIG. 37 is a schematic representation of the content management system instance 29A-4, and its exemplary databases 29A-5, as used by a plurality of front-end users, 29D-1, who consume content 29C-2, from an exemplary instance of the content management application 29A-4, for which they have been granted permission to access.

As shown, a plurality of steps for a flow of front-end steps to practice the timeline builder system 1. The front-end user 29D-1, first accesses a permitted instance of the application D2. The front-end user 29D-1, then views available content (index) filters D3. The front-end user 29D-1, then selects filters D4. The front-end user 29D-1, then receives a timeline of event summaries per the filter selections D5. The front-end user 29D-1, then selects events from a timeline D6. The front-end user 29D-1, then receives event displays D7. The front-end user 290-1, then consumes core content elements D8. The front-end user 29D-1, then selects optional content elements D9. The front-end user 29D-1, then receives optional content elements D10. The front-end user 29D-1, then consumes optional content elements D11. The front-end user 29D-1, then chooses another event from the current timeline, then repeats steps D-6-through D-11, D12. The front-end user 29D-1, lastly selects other filters to render a new or modified timeline, then repeats steps D-5 through D-11, D13.

It should be noted that various changes and modifications to the embodiments described herein will be apparent to those skilled in the art. Such changes and modifications may be made without departing from the spirit and scope of the present invention and without diminishing its intended advantages. For example, various embodiments of the systems and methods may be provided based on various combinations of the features and functions from the subject matter provided herein.

What is claimed is:

1. A timeline builder system comprises:
a content preparation module creating a back-end user framework in a plurality of bundles of content;
an event creation module retains and assembles a data set from the content preparation module;
a narrative display module receives an assembled data set and having:
a content filter module providing a plurality of content categories which are selected or deselected by a front-end user;
an event timeline module receives the plurality of content categories selected by the front-end user and displayed on a portion a screen of the narrative display module;
an event display module displays the plurality of content categories and permits the front-end user to explore and consume content related to the event timeline module; and
a fixed element module positioned across a top portion of the screen and providing a plurality of menu options.

2. The timeline builder system of claim 1, wherein the content preparation module includes a story template module.

3. The timeline builder system of claim 2, wherein the content preparation module further includes a media log module.

4. The timeline builder system of claim 3, wherein the content preparation module further includes an event publication summary module.

5. The timeline builder system of claim 4, wherein the event creation module includes a core event module.

6. The timeline builder system of claim 5, wherein the event creation module further includes an event access module.

7. The timeline builder system of claim 6, wherein the event access module allows a back-end user to set permission levels that control access to the plurality of content categories of the front-end user.

8. The timeline builder system of claim 7, wherein the event creation module further includes a topic module allowing back-end users to create hierarchical.

9. The timeline builder system of claim 8, wherein the event creation module further includes a tag module allowing back-end users to create non-hierarchical taxonomies.

10. The timeline builder system of claim 9, wherein the event creation module further includes a story module allowing back-end users to create custom sets of content independent of the topic module and the tag module.

11. The timeline builder system of claim 10, wherein the event creation module further includes a media library module.

12. The timeline builder system of claim 11, wherein the event creation module further includes a plurality of web services modules.

13. The timeline builder system of claim 12, wherein the plurality of content categories are selected or deselected by a switch.

14. The timeline builder system of claim 13, wherein the content filter module further includes a plurality of topics.

15. The timeline builder system of claim 14, wherein the content filter module further includes a plurality of tags.

16. The timeline builder system of claim 15, wherein the content filter module further includes a plurality of stories.

17. The timeline builder system of claim 16, wherein the content filter module further includes a plurality of collections.

18. The timeline builder system of claim 17, wherein the event timeline module includes a plurality of event summaries.

19. The timeline builder system of claim 18, wherein the plurality of event summaries further includes a display title and a display date.

20. The timeline builder system of claim 19, wherein the event display module further includes an event record module.
